(19) United States
(12) Patent Application Publication
(10) Pub. No.: US 2008/0171475 A1
(43) Pub. Date: Jul. 17, 2008

(54) Method and apparatus for an exemplary data patchbay

(76) Inventors: Dimitrios Antsos, Pasadena, CA (US); Glenn Garrard, Glendale, CA (US)

Correspondence Address: The Farrow Law Firm, 3031 Tisch Way, San Jose, CA, 95128, US

(21) Appl. No.: 11/654,366

(22) Filed: Jan. 15, 2007

(51) Int. Cl. H01R 13/10

(52) U.S. Cl. 439/668; 439/682

(57) ABSTRACT

A standard-width powered switching station, i.e. a patchbay, employing single-plug Bantam Audio patchcords inserted into front panel jacks, designed to provide bidirectional data communication connectivity, i.e. remote controlling, between up to 32 pairs of RS422-compliant controllers and remotes, connected to rear panel DE9 ports. The patchbay being further designed to auto-configure the DE9 ports, such that their receivers and drivers are appropriately configured to communicate with controllers or remotes connected to said ports. Said auto-configuration process being protected from contamination from stray voltages by switch chips. Said auto-configuration process alternatively being protected from contamination from stray voltages by separating the data channels from the auto-configuration circuitry, thus removing the need for switch chips. Said auto-configuration circuitry being further protected from contamination from parasitic receiver voltages by biasing circuitry. Said patchbay employing a visual means, i.e. LEDs, for verification that all controller and remote pairs are communicating correctly.

### BRIEF SUMMARY OF THE INVENTION

The invention herein described is an exemplary powered switching station, also known as a powered patchbay, for completing data connections between multiple controller (also known as master), and remote (also known as slave) devices. For purposes of this disclosure, a controller is an electronic device used in professional video broadcasting, capable of sending electronic signals, i.e. instructions, to other professional video broadcasting equipment. Similarly, for purposes of this disclosure, a remote is an electronic device used in professional video broadcasting, capable of receiving and carrying out instructions of a controller. The embodiments of the invention described herein refer, without limitations, to other RS422 compliant devices, i.e. in addition to professional video broadcasting equipment, the invention described herein will operate with any other RS422 compliant device employing the Sony or Lynx Remote Delegation communications protocols.

### LIST OF FIGURES

FIG. 1 is a prior art illustration of one controller device connected directly to one remote device.

FIG. 2 is a prior art illustration of one of many controller devices connected directly to one of many remote devices.

FIG. 3 is a prior art illustration of a traditional, unpowered, switching data patchbay.

FIG. 4a is a prior art illustration of a front view of a traditional, unpowered, switching data patchbay.

FIG. 4b is a prior art illustration of a rear view of a traditional, unpowered, switching data patchbay.

FIG. 5a is a prior art illustration of a dual-plug Bantam Audio patchcord, which can carry the two RS422 differential communications signals on four conductors.

FIG. 5b is a prior art illustration of a single plug Bantam Audio patchcord.

FIG. 6 is a prior art illustration of the schematic of the inside of a traditional, unpowered, switching data patchbay.

FIG. 7 is a prior art illustration of a controller and a remote that are connected to the DE9 connectors on the rear panel of the patchbay. A dual-plug Bantam Audio patchcord in the corresponding jacks on the front panel of the patchbay completes the connection between the controller and the remote.

FIG. 8a illustrates a front view of the new Bittree powered patchbay. On the front panel can be seen the two rows of 32 single Bantam Audio jacks and the two rows of 64 LEDs (two per jack).

FIG. 8b illustrates a rear view of the new Bittree powered patchbay. On the rear panel can be seen the two rows of 32 DE9 connectors as well as the power jack.

FIG. 9a illustrates one of the 32 PC-boards inside the patchbay, on which the electronic circuitry of the patchbay is mounted. The front panel jacks connected to this PC-board are shown behind it, in 3-dimensional perspective.

FIG. 9b illustrates a side-view schematic representation of one of these 32 identical vertical “slices” of the invention.

FIG. 10 illustrates a schematic representation of the circuitry of one of the two DE9 connectors on each of the 32 identical PC-boards in the invention.

FIG. 11 illustrates a schematic representation of one of the 32 identical slices of the invention, without the switch chip.

FIG. 12 illustrates a schematic representation of two of the 32 identical PC-boards in the invention, without a switch chip, connected through the front panel jacks via a patchcord.

FIG. 13a illustrates a controller and a remote connected to the DE9 connectors on the rear panel of the patchbay. A single plug, Bantam Audio patchcord in the corresponding jacks on the front of the patchbay completes the connection between the controller and the remote.

FIG. 13b illustrates a high-level flow diagram of the invention in operation.

FIG. 14 illustrates two devices connected to vertically-aligned rear panel DE9 connectors of a patchbay, and therefore to each other, via the normaling connection, for purposes of communication.

FIG. 15 illustrates a high-level flow diagram of connecting two devices to vertically-aligned DE9 connectors of the invention.

FIG. 16 illustrates a high-level flow diagram of the signal path, when a controller and a remote are communicating through the invention.

FIG. 17 illustrates a high-level flow diagram of the method of determining whether an unknown device connected to the rear panel DE9 connectors of the invention is a controller or a remote.

FIG. 18 illustrates a high-level flow diagram of a method of preventing a receiver of another device from imposing a parasitic voltage on the input lines of the invention, thus being inadvertently misidentified as a driver.

FIG. 19 illustrates a high-level schematic representation of the second embodiment of the auto-configuration circuitry, which does not require a switch chip.

FIG. 20 illustrates a more detailed schematic drawing of this second embodiment of the auto-configuration circuitry.

FIG. 21 illustrates a high-level flow diagram of the invention using the second embodiment of the auto-configuration circuitry.

FIG. 22 illustrates a schematic representation of two of the 32 identical PC-boards in the invention, with the second embodiment of the auto-configuration circuitry, connected through the front panel jacks via a patchcord. In this second embodiment, a switch chip is no longer necessary to prevent voltages from other configured ports from contaminating the auto-configuration process.

### BACKGROUND

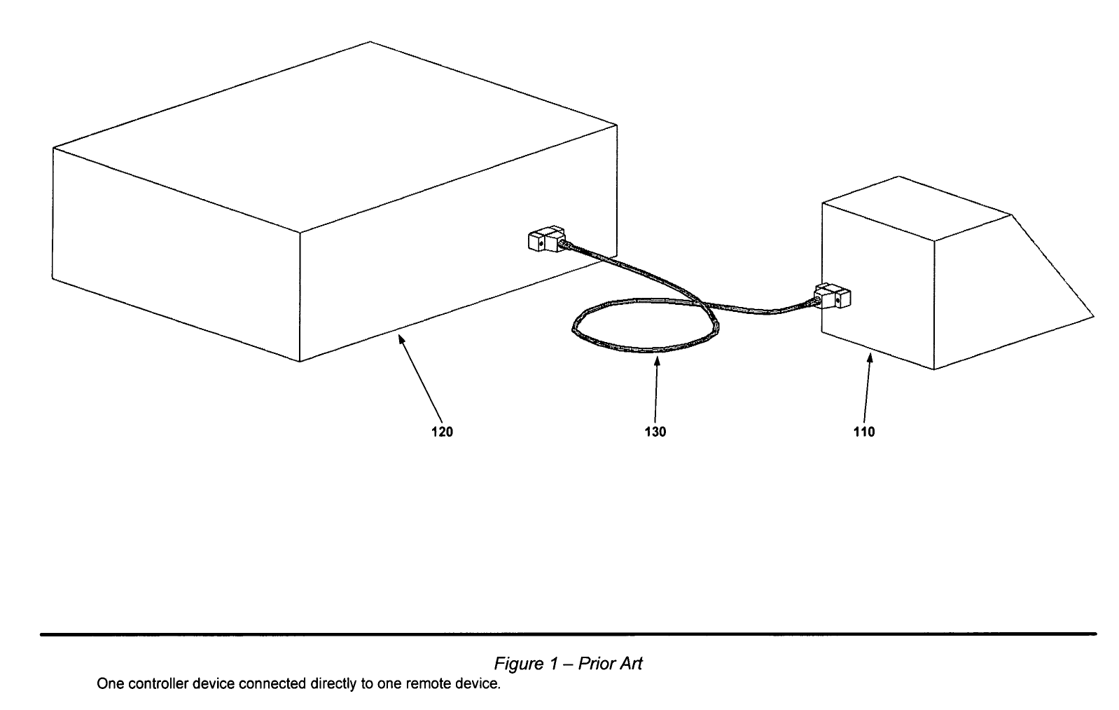

Referring to FIG. 1, in the simplest controller/remote configuration, Controller (110) is connected directly to Remote (120) via Cable (130), terminated at both ends with 9-pin D-type subminiature (DE9) plugs. For purposes of this disclosure, Controller (110) is a device capable of sending instructions to another device, which is not permanently connected to Controller (110). Similarly, for purposes of this disclosure, Remote device (120) is a device which receives instructions from Controller (110).

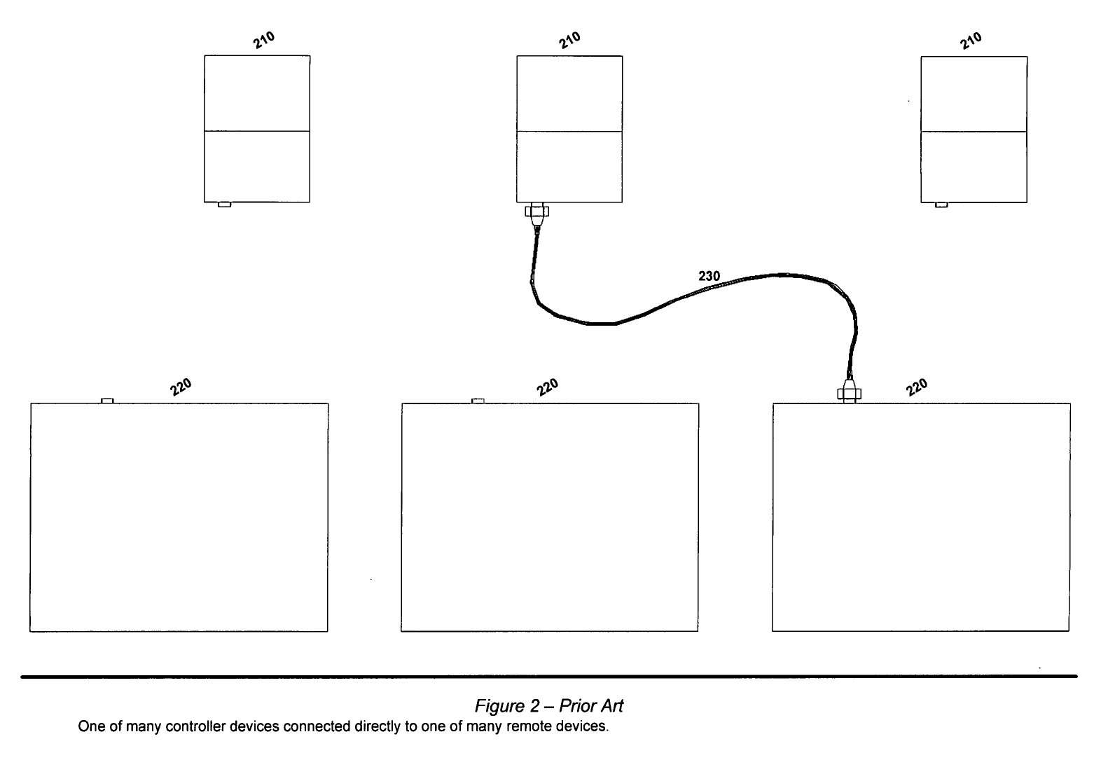

It is often desirable that Controller (110) is able to control different remote devices at different times, and that Remote (120) is able to receive instructions from different controllers. Referring to FIG. 2, the most obvious way to achieve this is to simply connect the desired Controller (210) to the desired Remote (220) via DE9 Cable (230). When a new configuration is desired, simply disconnect DE9 Cable (230) from one Controller (210) and one Remote (220), and connect to a new controller/remote combination.

Unfortunately, this method has numerous limitations and drawbacks, including the physical challenge of managing a large number of devices, the relatively small number of connector insertions permitted on some delicate equipment, and the inaccessibility of traditionally rear mounted connectors on most electronics.

### DESCRIPTION OF PRIOR ART

One general solution to this problem has been the switching data patchbay. A traditional data patchbay is an unpowered switching station with the ability to route electric signals from a multitude of Controllers (110) to a multitude of Remotes (120).

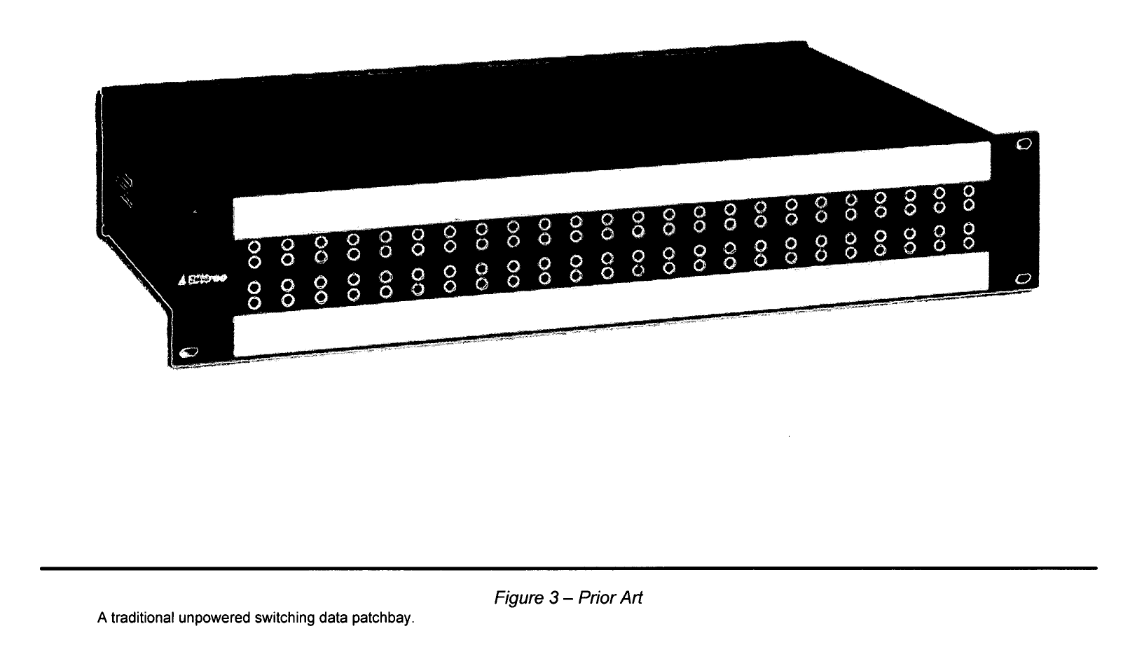

FIG. 3 is an example of a traditional, unpowered data patchbay. There are many types of patchbays, each designed to carry a different type of electric signal. Some of the different types of patchbay include the data patchbay, the video patchbay, and the audio patchbay. This disclosure is primarily concerned with the data patchbay.

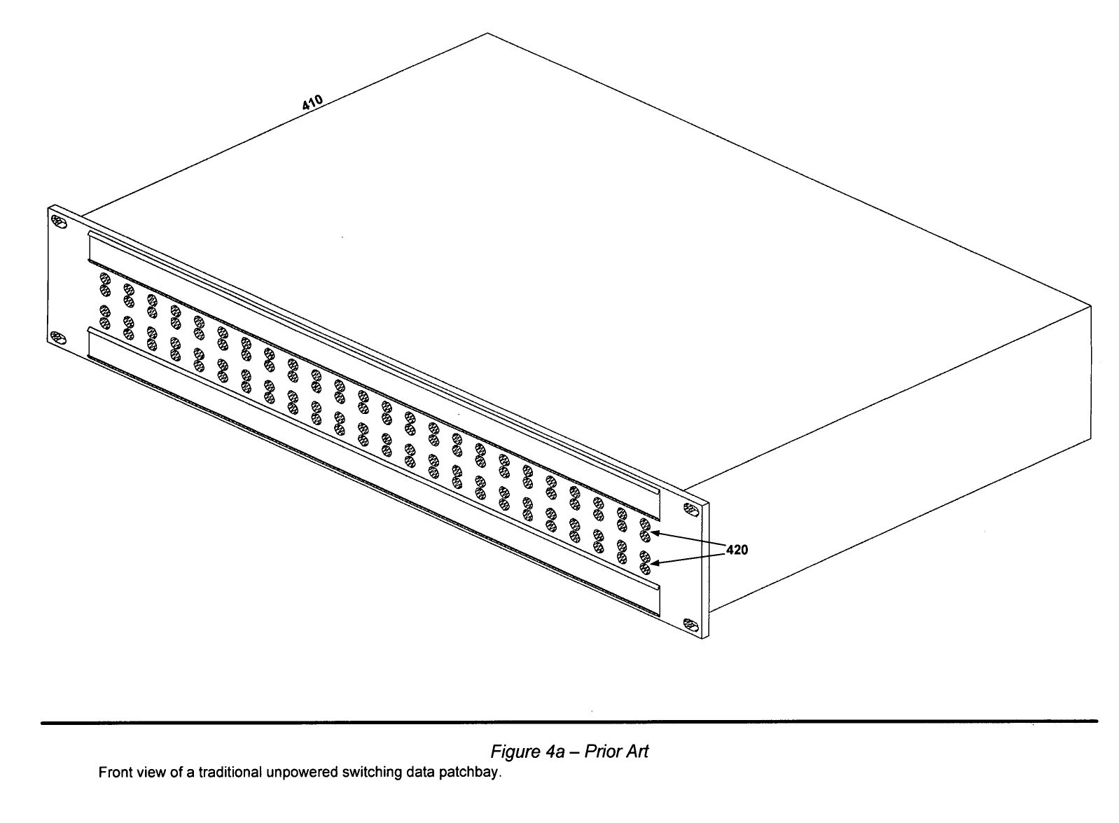

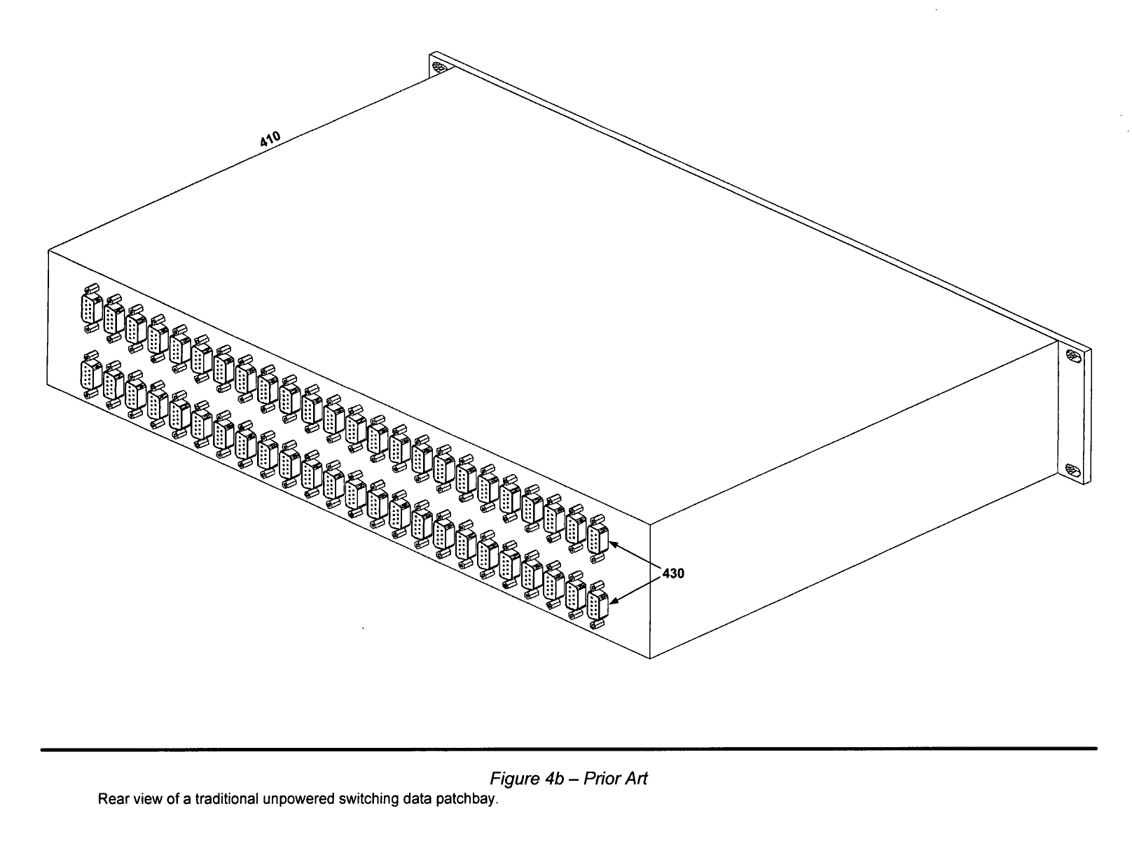

FIG. 4a illustrates the front of traditional, unpowered Data Patchbay (410). On the front panel of Data Patchbay (410) are 2 rows of 24 columns of dual Bantam Audio Jacks (420), which allow cross-connections between the devices connected to connectors on the rear panel of Data Patchbay (410), using special cables called patchcords. FIG. 4b illustrates the back of Data Patchbay (410). On the rear panel of Data Patchbay (410) are 2 rows of 24 columns of DE9 connectors (430). In the video broadcast industry preferred configuration, Data Patchbay (410) has 32 columns. However, any number of columns is permissible.

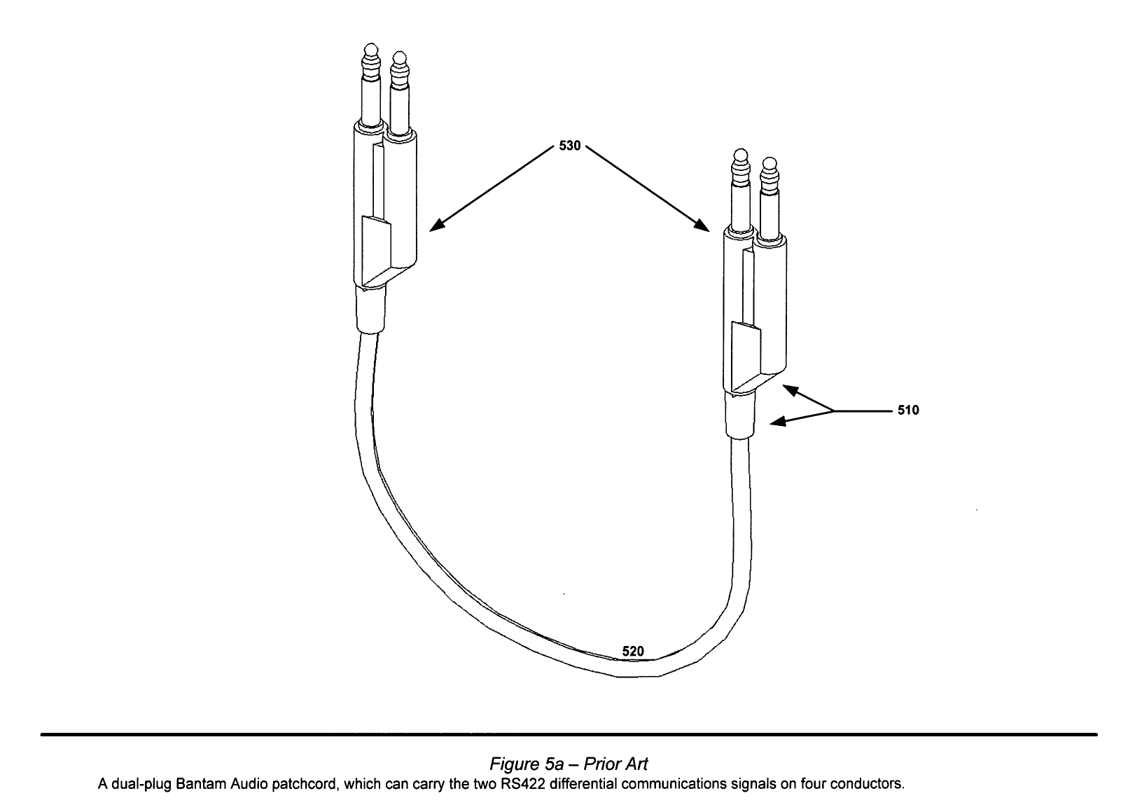

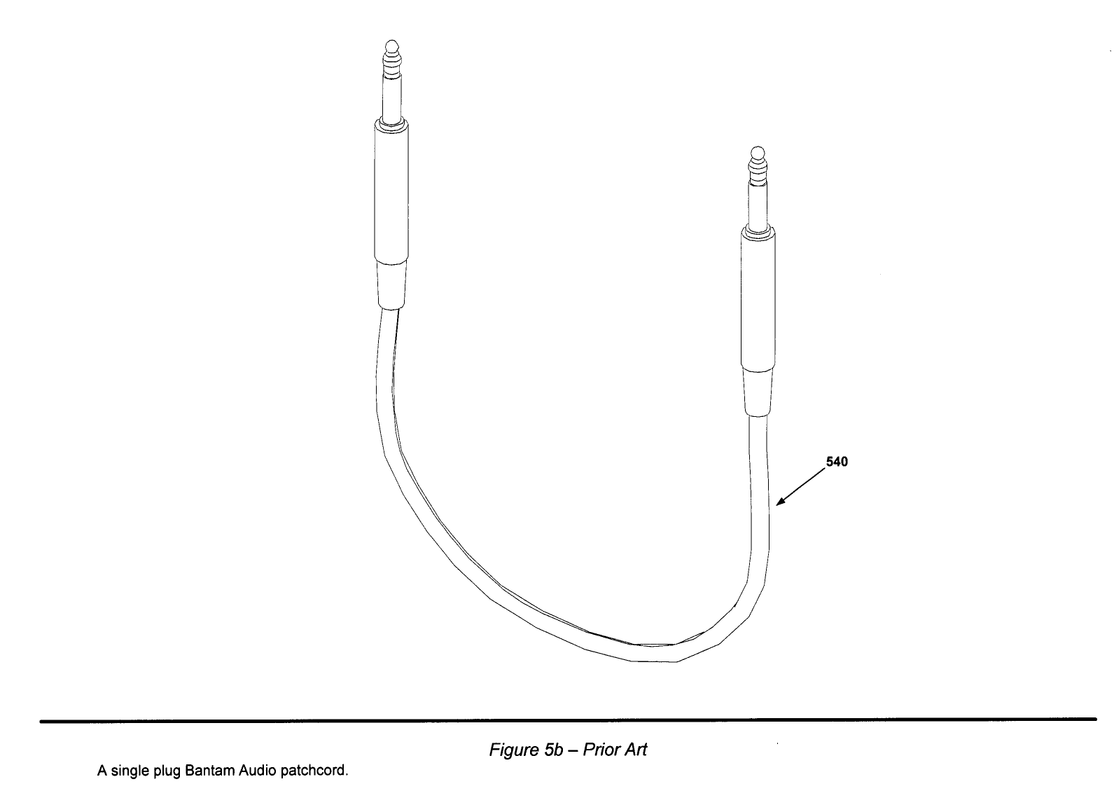

FIG. 5a illustrates Patchcord (510), a flexible piece of Cable (520) terminated at both ends with Plugs (530), used for interconnecting electrical circuits that terminate in jacks. In one embodiment of traditional, unpowered Data Patchbay (410), the Plugs (530) of Patchcord (510) are dual-plug Bantam Audio plugs, which can carry two RS422 communications signals on four wires. FIG. 5b illustrates Patchcord (540), a simpler, more common type of patchcord, which employs single-plug Bantam Audio plugs at both ends. Two single-plug Patchcords (540) could also be used in place of one dual-plug Patchcord (510) to achieve cross-connectivity between devices connected to Patchbay (410).

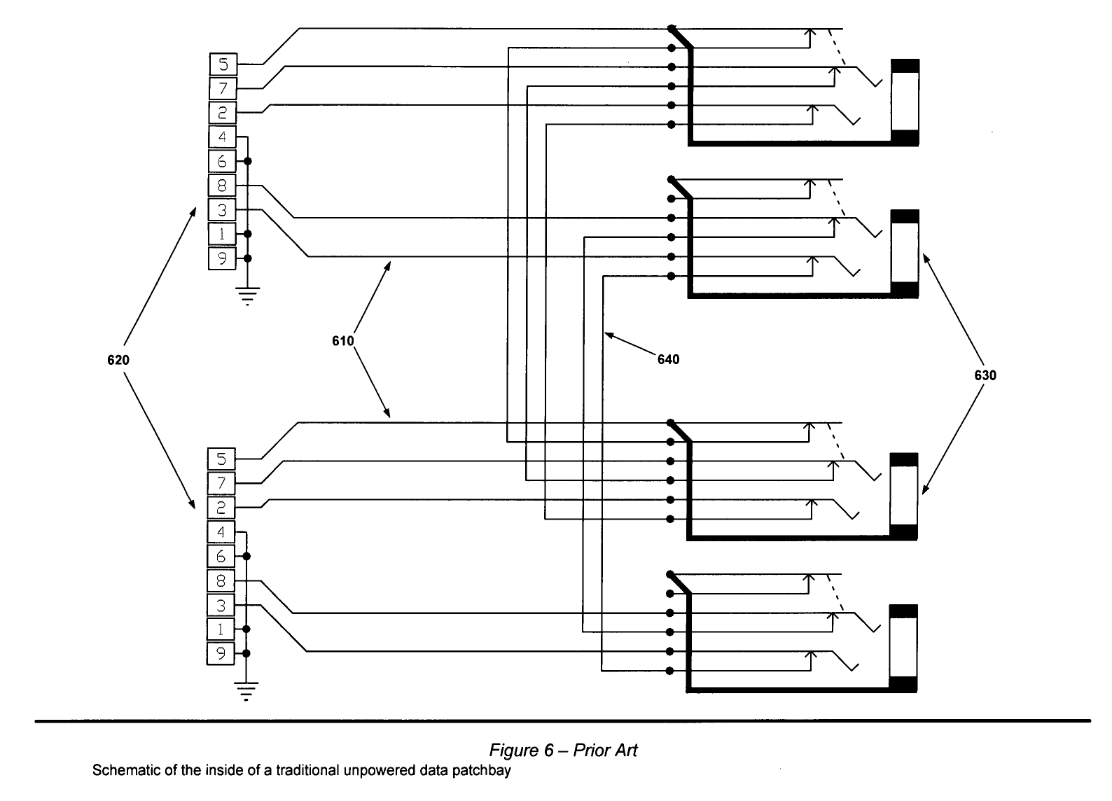

The traditional, unpowered patchbay functions as a switch designed to provide cross-connectivity between controller and remote devices connected to the DE9 connectors on its rear panel. Referring to FIG. 6, the inside of Patchbay (410) contains multi-wire Ribbon Cables (610) which connect DE9 Connectors (620), located on the rear panel of the patchbay, to Bantam Audio Jacks (630), located on the front panel of the patchbay, as illustrated schematically in FIG. 6. Jacks (630) are mounted on Printed Circuit Boards (PC-Boards) that are parallel to the front panel of the patchbay. PC-Board Traces or Wires (640), running between vertically aligned Jacks (630), provide connectivity between those jacks in the absence of a patchcord, hence creating a default connection called a “normaling” connection.

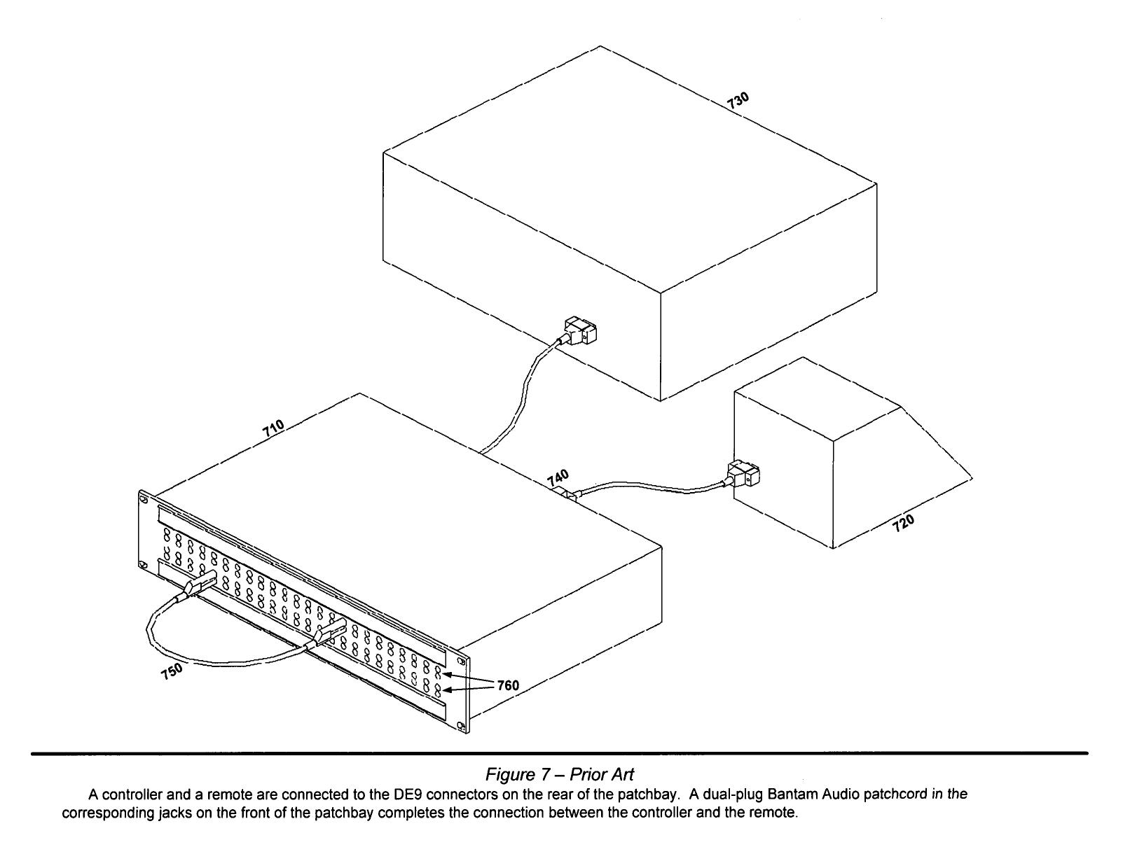

FIG. 7 illustrates Controller (720) and Remote (730) connected to the DE9 Connectors (740) on the rear panel of Patchbay (710). To make a data connection between Controller (720) and Remote (730), Patchcord (750) is inserted into the easily accessible front panel of Patchbay (710) in the appropriate Jacks (760) that correspond to the rear DE9 Connectors (740) to which Controller (720) and Remote (730) are connected.

The Electronics Industries Alliance Recommended Standard 422 (EIA RS422) communications protocol is the standard currently used in the video broadcast industry to communicate between controller and remote devices. The RS422 is a serial digital interface standard or protocol, which specifies the electrical characteristics of balanced (differential) voltage digital interface circuits. This signaling protocol governs the asynchronous transmission of computer data at speeds of up to 920,000 bits per second. A standard single-plug Bantam Audio patchcord, which has a maximum of three wires available to carry signals, is insufficient to carry the full transmit and receive communications of the RS422 protocol, which requires at least four wires, i.e. two wires to carry the transmit signal and another two wires to carry the receive signal. One front panel standard, single Bantam Audio jack per Controller or Remote device is therefore insufficient to carry the two RS422 communication signals required for bidirectional communication.

A current approach to building an RS422-capable data patchbay is using dual jacks that require specialized patchcords like Patchcord (510), which is a double-head or dual-plug Bantam Audio patchcord, as shown in FIG. 5a. Dual-plug Patchcord (510) has sufficient wires to carry the RS422 compliant set of two signals on four wires. However, the dual Bantam Audio Jacks used with these patchcords are wider, when mounted in a vertical configuration, than single Bantam Audio jacks. By industry convention, 2 rows of 32 columns of jacks and corresponding rear-panel DE9 ports are desired, resulting in a standard width patchbay that can cross-connect up to 64 devices. With the dual jack configuration, however, there is only enough horizontal space for 2 rows of 24 Jacks (420) in standard-width Patchbay (410), enabling it to cross-connect up to 48 devices, as shown in FIG. 4a. As a result, the number of patchbays needed to cross-connect a given number of devices increases by approximately 33 percent, which also translates into a variety of additional costs.

Another currently used approach to building an RS422-capable data patchbay is by changing from the traditional co-axial or circular jack/patchcord system to a system in which the end of the patchcord is a thin PC-board with enough copper traces to carry and connect an RS422 compliant set of signals. By virtue of the fact that the corresponding PC-board jacks are narrower than the dual Bantam Audio jacks, this system has the benefit of accommodating the routing of the RS422 signals, while conforming to the industry convention of 2 rows of 32 columns of ports on both the front and the rear panel of the patchbay. This solution is fraught with problems, however, in that it introduces a host of issues not common to patchbays which use standard Bantam Audio jacks. Specifically, the copper traces on the PC-board connectors are susceptible to, among other things, dirt, fingerprints, and oxidation. Patchcords employing PC-boards are also substantially more expensive than standard Bantam Audio patchcords. Finally, the point where the patchcord changes from the flat geometry of a PC-Board into the round geometry of a wire has a high likelihood of stress induced failure, which commonly results in broken wires.

### INTRODUCTION TO THE INVENTION

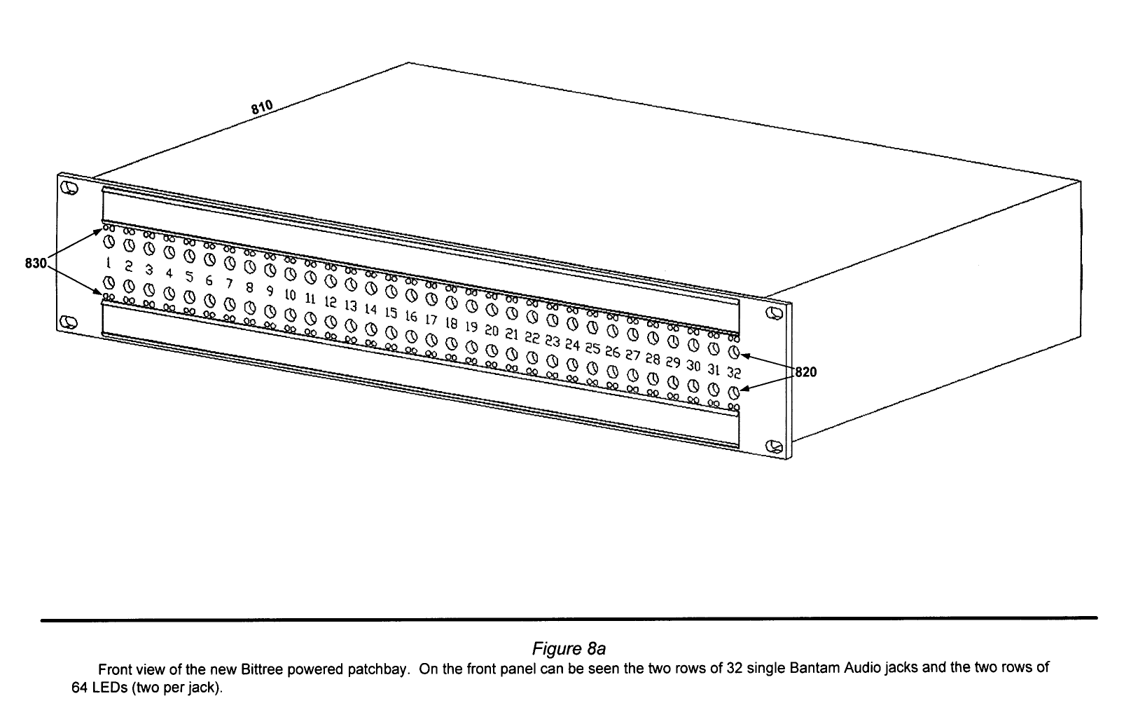

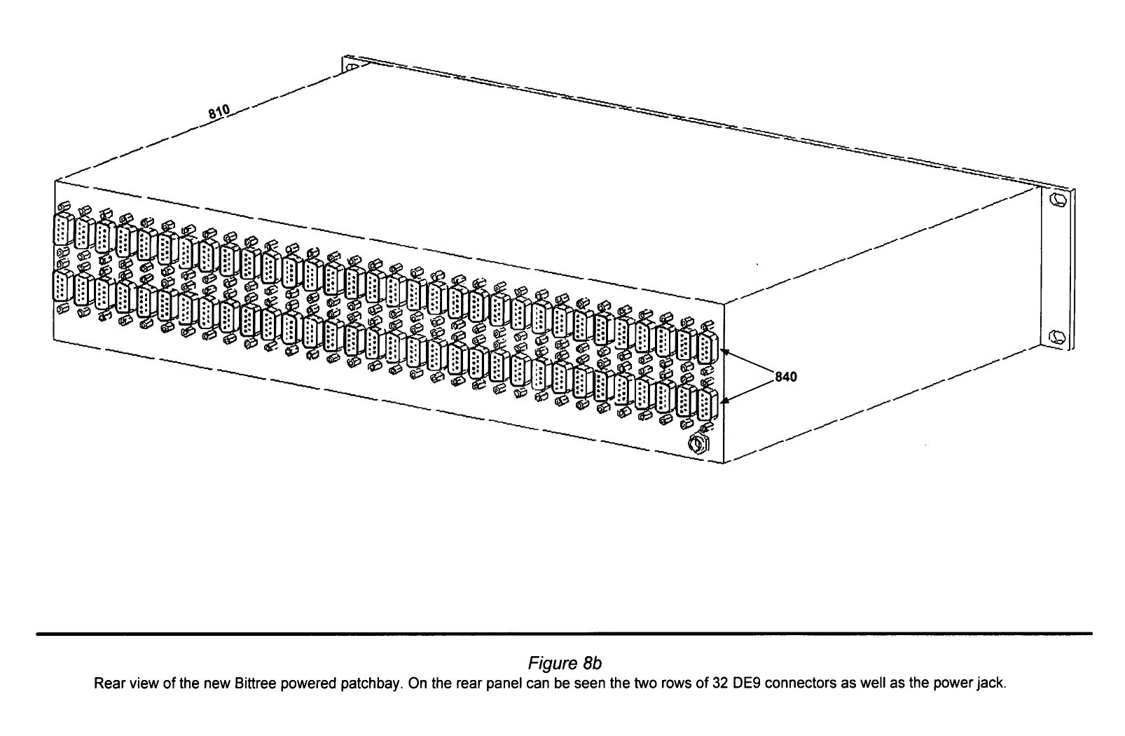

FIGS. 8a and 8b illustrate front and back views respectively of the exemplary invention described herein, i.e. a 2-row by 32-column single-jack, standard-width, powered Patchbay (810), which uses standard single Bantam Audio Jacks (820) and standard single-plug Bantam Audio Patchcords (540). The invention includes a powered Patchbay (810) with electronic circuits that convert each differential RS422 signal, carried on two wires, into a single-ended +5 Volt Transistor-to-Transistor Logic (TTL) signal, carried on a single wire and a common wire called “ground.” This signal can thus be carried over a standard Bantam Audio Jack and single-plug Patchcord (540) and reconstituted into an RS422 signal by electronic circuitry connected to the receiving DE9 connector (840). As a further enhancement, the invention includes two rows of Light Emitting Diodes (830) (LEDs), which act as indicator lights and add diagnostic capabilities to the system.

Alternatively, in another embodiment, the invention may use a powered patchbay system wherein the electronic circuits convert the two differential RS422 signals (send and receive), carried on 4 wires, into two equivalent single-ended RS232 signals, instead of TTL signals, carried on 2 wires and ground.

In yet another embodiment, the invention may convert the two differential RS422 signals, carried on 4 wires, into two equivalent single-ended signals of any type, carried on two wires and ground.

### DETAILED DESCRIPTION OF THE PREFERRED EMBODIMENTS

The invention described herein is an exemplary powered patchbay consisting of a 2 by 32 matrix of DE9 connectors, thirty-two vertically mounted circuit boards each carrying two vertically aligned DE9 connectors, a 2 by 32 matrix of standard, single Bantam Audio Jacks, LEDs, and a power supply.

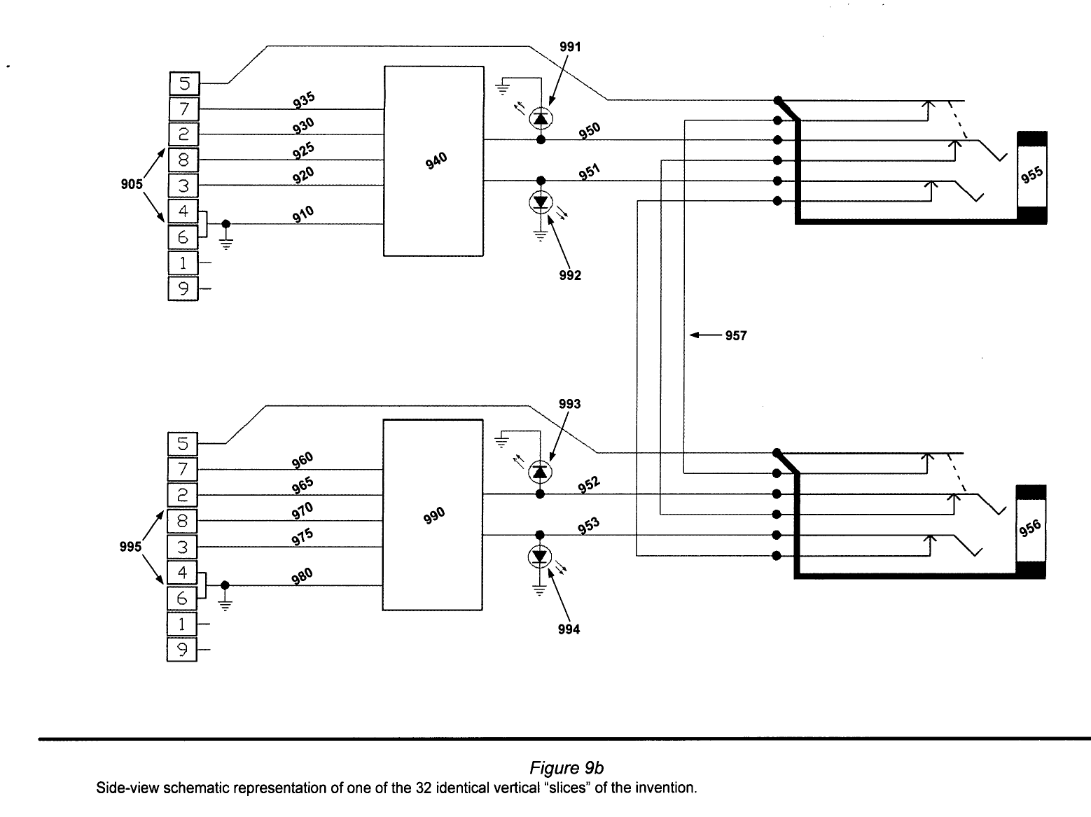

Referring to FIG. 9a, FIG. 9a illustrates an example of one of the thirty-two vertically mounted circuits boards, hereinafter referred to as PC-Boards, of the invention. Two DE9 Connectors (902a) and (903a) are mounted on PC-Board (901). Jacks (902b) and (903b) are mounted on another PC-Board near the front panel of the powered patchbay. Ribbon cables connect this other PC-Board to PC-Board (901), such that DE9 Connectors (902a) and (903a) are connected to Jacks (902b) and (903b) respectively. Hence, DE9 Connector (902a) is located right behind Jack (902b) and DE9 Connector (903a) is located right behind Jack (903b). Also by convention, vertically aligned Jacks (902b) and (903b) are connected by default, in the absence of Patchcord (540) inserted into them.

FIG. 9b shows a two-dimensional schematic side-view of one of the 32 identical vertical PC-Boards (790) or “slices” of the invention and the jacks connected to that PC-Board. On the left side of the schematic diagram, which corresponds to the rear panel of the invention, are DE9 Connectors or Ports (905) and (995), each with pins numbered (1) through (9). DE9 Ports (905) and (995) are vertically aligned, i.e. they are physically mounted on the same PC-Board (790). In one scenario, Controller (720) is connected to DE9 Port (905) and Remote (730) is connected to DE9 Port (995). In the RS422 signaling protocol used in the video broadcast industry, pins (8) and (3) of DE9 Port (905) receive a differential signal from Controller (720), and pins (7) and (2) transmit a response signal to Controller (720). Conversely, pins (8) and (3) of DE9 Port (995) transmit Controller's (720) signal to Remote (730), and pins (7) and (2) receive the response signal from Remote (730) connected to DE9 Port (995).

In the reverse scenario, Controller (720) is connected to DE9 Port (995) and Remote (730) is connected to the vertically aligned top port, DE9 Port (905). Pins (8) and (3) of DE9 Port (995) now receive the signal from Controller (720) and pins (7) and (2) of DE9 Port (995) transmit the response of Remote (730) to Controller (720). Conversely, pins (8) and (3) of DE9 Port (905) transmit the Controller's (720) signal to Remote (730) and pins (7) and (2) of DE9 Port (905) receive the response signal from Remote (730).

Referring to the first scenario, Controller (720) routes data through pins (8) and (3) of DE9 Port (905) to PC-Board (901), the purpose of which is to convert this received data signal from a two-wire differential signal into a single-ended signal on one wire, i.e. a signal which is carried between a single wire and another common wire called “ground,” which may be shared by other signals. In the specific embodiment of the invention, RS485/RS422 Transceiver Chip (940), which is mounted on PC-Board (901), converts the two-wire differential signal carried on Lines (920) and (925) into a one-wire TTL signal carried on Line (951) and the ground wire of the powered patchbay. This single-ended electrical signal travels to Jack (955), which is mounted on the front panel of the patchbay. LED (992), which is also mounted on the front panel of the patchbay, is connected to Line (951). As the voltage on Line (951) changes during communication, LED (992) blinks. This confirms to the user that a controller has been plugged into DE9 Port (905) and is transmitting successfully.

Once the signal reaches Jack (955), it can travel in one of two paths. As previously mentioned, the vertically aligned Jacks (955) and (956) are connected by default, i.e. in the absence of a patchcord inserted into either of them. This default connection is known as a “normaling” connection. However, should Patchcord (540) be inserted into either Jack (955) or Jack (956), this vertical normaling connection between Jack (955) and Jack (956) will be broken, and the signal will follow the path of Patchcord (540).

Referring again to FIG. 9b, when Patchcord (540) is plugged into Jack (955) the singled-ended TTL communications signal leaves Jack (955) and travels along Patchcord (540) to a jack to which the other end of Patchcord (540) is plugged. Assuming that Patchcord (540) is plugged into Jacks (955) and (956), the signal travels to Jack (956), then onwards to Transceiver Chip (990) via Line (953), where the signal is reconstituted into a differential signal, traveling along Lines (970) and (975) to DE9 Port (995), which is finally transmitted via pins (8) and (3) of DE9 Port (995) to Remote Device (730). Additionally, LED (994) will blink due to the varying voltage of the data signal on Line (953).

Controller (720) and Remote (730) herein mentioned communicate using the video broadcast industry standard Sony or Lynx Remote Delegation Protocols. These are protocols that specify how one video device, like Controller (720), needs to address another video device, like Remote (730), in order to remotely control its operation. Specifically, Controller (720) initially sends a hailing signal designed to elicit an acknowledgment signal from Remote (730). If Remote (730) is properly connected and in good working order, it will send an acknowledgment signal back to Controller (720) via pins (7) and (2) of DE9 Port (995). This will cause LEDs (991) and (993), which are a different color from the aforementioned LEDs (992) and (994), to blink. LEDs of different color are chosen to make it easier to diagnose communication problems. This acknowledgement signal from Remote (730) travels the reverse but parallel path, and is received by Controller (720) via pins (7) and (2) of DE9 Port (905). Thus, when the controller and remote are correctly connected, LEDs (991), (992), (993) and (994) will all receive power and be turned on. In the specific embodiment of this invention, a turned on LED blinks.

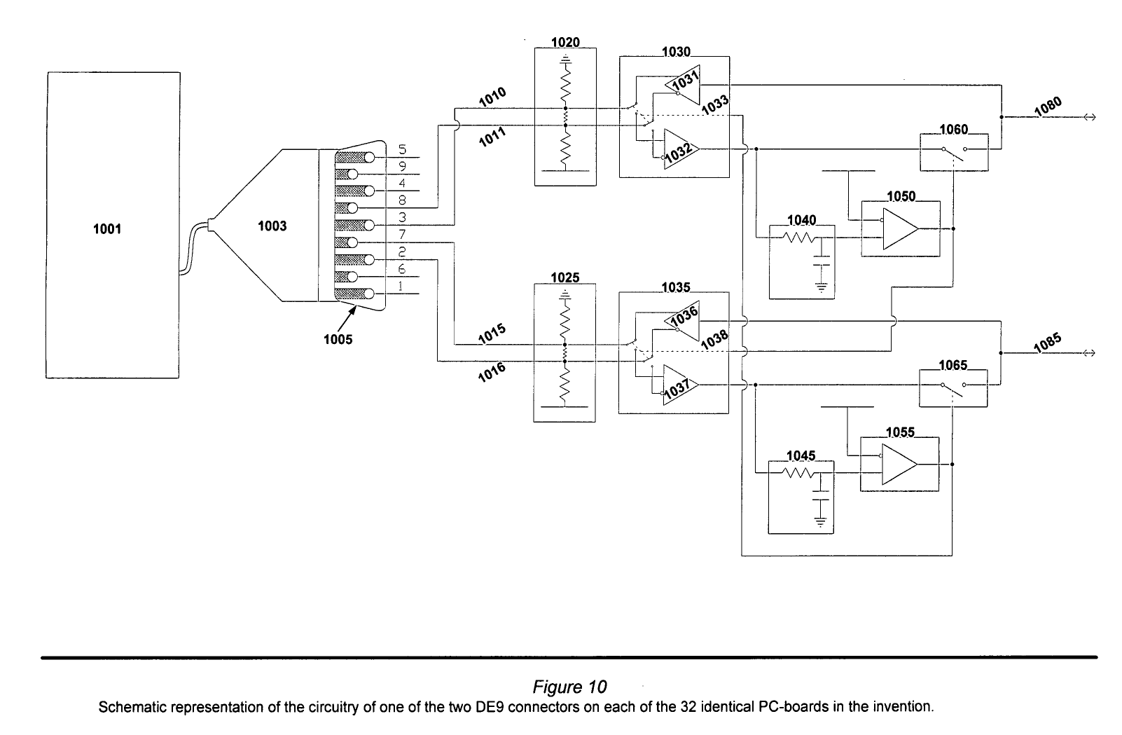

Referring to FIG. 10, as a further element of novelty in the invention, the invention determines whether Unknown Device (1001), which is connected to DE9 Port (1005) via DE9 Plug (1003), is a controller device or a remote device, and auto-configures RS422 Transceiver Chips (1030) and (1035) accordingly. FIG. 10 is a more detailed schematic diagram of the upper half of an internal circuit board, i.e. PC-Board (901), of the invention, and of Unknown Device (1001) connected to DE9 Port (1005) of the invention. The invention must determine whether RS422 Transceiver Chips (1030) and (1035) should be configured to transmit or to receive information. Initially, in the absence of a device connected to DE9 Port (1005), D/ R̅ (Driver/Receiver) Select Pins (1033) and (1038) of RS422 Transceiver Chips (1030) and (1035) are set to a voltage of 0 Volts, or grounded, with a result that both RS422 Transceiver Chips (1030) and (1035) are initially configured as receivers. However, if Unknown Device (1001) connected to DE9 Port (1005) via DE9 Plug (1003) is a controller device, i.e. Controller (720), it imposes a voltage on pins (8) and (3) of DE9 Port (1005). As Controller (720) sends out its hailing signal, the voltage between these pins varies, creating the signal. This hailing signal, which conforms to the Sony or the Lynx Remote Delegation Protocol, consists of mostly “logic high” voltage levels, with a few “logic lows” in between. As a result its average value is very near the logic high voltage level, which when converted to a TTL voltage by RS422 Transceiver Chip (1030) results in a voltage with average value very near +5 Volts. Resistor-Capacitor Averaging Circuit (1040) averages the converted TTL voltage at the output of RS422 Transceiver Chip (1030). When this average voltage exceeds +2.5 Volts, the output of Comparator Chip (1050) sets D/ R̅ Select Pin (1038) to a logic high voltage (+5 Volts), which means that RS422 Transceiver Chip (1035) ceases to be an RS422 receiver chip, and will now act as an RS422 driver chip instead. RS422 Transceiver Chip (1035) is now appropriately configured to send the response of Remote (730) back to Controller (720), after Remote (730) is connected to another DE9 Port routed via the front panel jacks to DE9 Port (1005).

Conversely, if Unknown Device (1001) connected to DE9 Port (1005) via DE9 Plug (1003) is a remote device, i.e. Remote (730), it imposes a logic high voltage on pins (7) and (2) of DE9 Port (1005), even before it starts communicating with a controller. This signal is converted to a +5 Volt single-ended TTL signal by RS422 Transceiver Chip (1035). Averaging Circuit (1045) averages this voltage. When the output voltage of Averaging Circuit (1045) exceeds +2.5V, Comparator Chip (1055) configures RS422 Transceiver Chip (1030) as a driver. RS422 Transceiver Chip (1030) is now appropriately configured to forward the commands of Controller (720) to Remote (730), after Controller (720) is connected to another DE9 Port the signals of which are routed via the front panel jacks to DE9 Port (1005).

Referring again to FIG. 10, as yet another element of novelty, the invention includes a means of preventing parasitic voltages from contaminating the auto-configuration of RS422 Transceiver Chips (1030) and (1035). An RS422 receiver interprets the voltage of the differential signal connected to its input and outputs a corresponding single-ended TTL voltage at its output. If Unknown Device (1001) is a controller, then pins (7) and (2) of DE9 Plug (1003), which is intended for connections enabling remote operations, are internally connected to an RS422 receiver, which should only “listen” for signals externally imposed on those pins. Unknown Device (1001) should not impose any voltage on these pins, which is equivalent to “talking.” However, sometimes RS422 receivers do impose a voltage at their input. A voltage imposed by an RS422 receiver at its input is known as a “parasitic voltage.” Parasitic voltages imposed by RS422 receivers tend to have very high impedances, in the range of 2000 to 3000 Ohms. Conversely, voltages imposed by RS422 drivers, such as the driver in RS422 Transceiver Chip (1030), tend to have low impedances, in the neighborhood of 40 Ohms.

Whenever two or more voltages are imposed on the same pair of wires, the voltage with the lowest impedance prevails. Thus, the invention includes Biasing Circuits (1020) and (1025) that have driving impedance higher than that of a legitimate RS422 driver, yet lower than that of the parasitic voltage at the input of an RS422 receiver. Experimentation suggests that a driving impedance near 1000 Ohms is optimal for Biasing Circuits (1020) and (1025). Biasing Circuits (1020) and (1025) each impose a negative voltage of −5 Volts on Lines (1010) and (1011) and Lines (1015) and (1016) respectively. For any input voltage greater than +0.2 Volts on Lines (1010) and (1011), RS422 Transceiver Chip (1030) outputs a single-ended voltage of +5 Volts, when configured as a receiver. Similarly, for any input voltage greater than +0.2 Volts on Lines (1015) and (1016), RS422 Transceiver Chip (1035) outputs a single-ended voltage of +5 Volts, when configured as a receiver. For any input voltage below +0.2 Volts on Lines (1010) and (1011), RS422 Transceiver Chip (1030) outputs a single-ended voltage of 0 Volts, when configured as a receiver. Similarly, for any input voltage below +0.2 Volts on Lines (1015) and (1016), RS422 Transceiver Chip (1035) outputs a single-ended voltage of 0 Volts, when configured as a receiver. The biasing voltage of −5 Volts imposed on Lines (1010) and (1011), and Lines (1015) and (1016) by Biasing Circuits (1020) and (1025) respectively ensures that their respective outputs of RS422 Transceiver Chips (1030) and (1035) will stay low (0 Volts) when there is nothing connected to their respective inputs. Should Lines (1010) and (1011) experience a voltage imposed by the RS422 driver of Unknown Device (1001) when this device is a controller device, i.e. Controller (720), connected to DE9 Port (1005) via DE9 Plug (1003), the impedance of the Controller's (720) RS422 driver will be lower than that of Biasing Circuit (1020), and the voltage of Lines (1010) and (1011) will be controlled by the RS422 driver of Controller (720), as intended. Conversely, should Lines (1010) and (1011) experience a parasitic voltage imposed by the RS422 receiver of Unknown Device (1001) when this device is a remote device, i.e. Remote (730), connected to DE9 Port (1005) via DE9 Plug (1003), the impedance of the Remote's (720) RS422 receiver will be higher than that of Biasing Circuit (1020), and the voltage of Lines (1010) and (1011) will be controlled by Biasing Circuit (1020), as intended. In this case, therefore, the voltage of Lines (1010) and (1011) will stay close to −5 Volts, well below the +0.2 Volt input threshold voltage of RS422 Transceiver Chip (1030), so the output of RS422 Transceiver Chip (1030) will stay low, i.e. 0 Volts, and hence opposing RS422 Transceiver Chip (1035) will not be erroneously configured as a driver. In the absence of Biasing Circuit (1020), the parasitic voltage imposed by the RS422 receiver of Remote (730) connected to DE9 Port (1005) via DE9 Plug (1003) could drive Lines (1010) and (1011) higher than the input threshold voltage of +0.2 Volts, thus causing RS422 Transceiver Chip (1030), which is configured as a receiver, to misinterpret the parasitic receiver voltage as that of a legitimate driver, and output a “high” voltage, i.e. +5 Volts. This high voltage, which is higher than the +2.5 Volts threshold of Comparator Chip (1050), will drive the output of Comparator Chip (1050) high, i.e. +5 Volts, and erroneously configure RS422 Transceiver (1035) as a driver. However, the presence of a lower impedance biasing voltage, imposed by Biasing Circuit (1020), will cause the voltage of Lines (1010) and (1011) to stay below the +0.2 Volt input threshold voltage of the receiver of RS422 Transceiver Chip (1030), and thus the output of RS422 Transceiver Chip (1030) will stay at 0 Volts, and the input of Comparator Chip (1050) will not be influenced by the parasitic receiver voltage.

In yet a further addition to the invention, the invention includes two switch chips, Switch Chips (1060) and (1065), called High Speed CMOS Logic Quad Bilateral Switch Chips. Switch Chips (1060) and (1065) are designed to switch a circuit from open to closed and vice-versa. Switch Chips (1060) and (1065) in this invention serve two purposes. Firstly, they isolate Averaging Circuits (1040) and (1045) from contamination by signals from RS422 Transceiver chips, like RS422 Transceiver Chips (1030) and (1035), of other DE9 ports. Secondly, Switch Chips (1060) and (1065) prevent RS422 Transceiver Chips (1030) and (1035) from prematurely sending information to the transceiver chips of other DE9 ports, via the jacks.

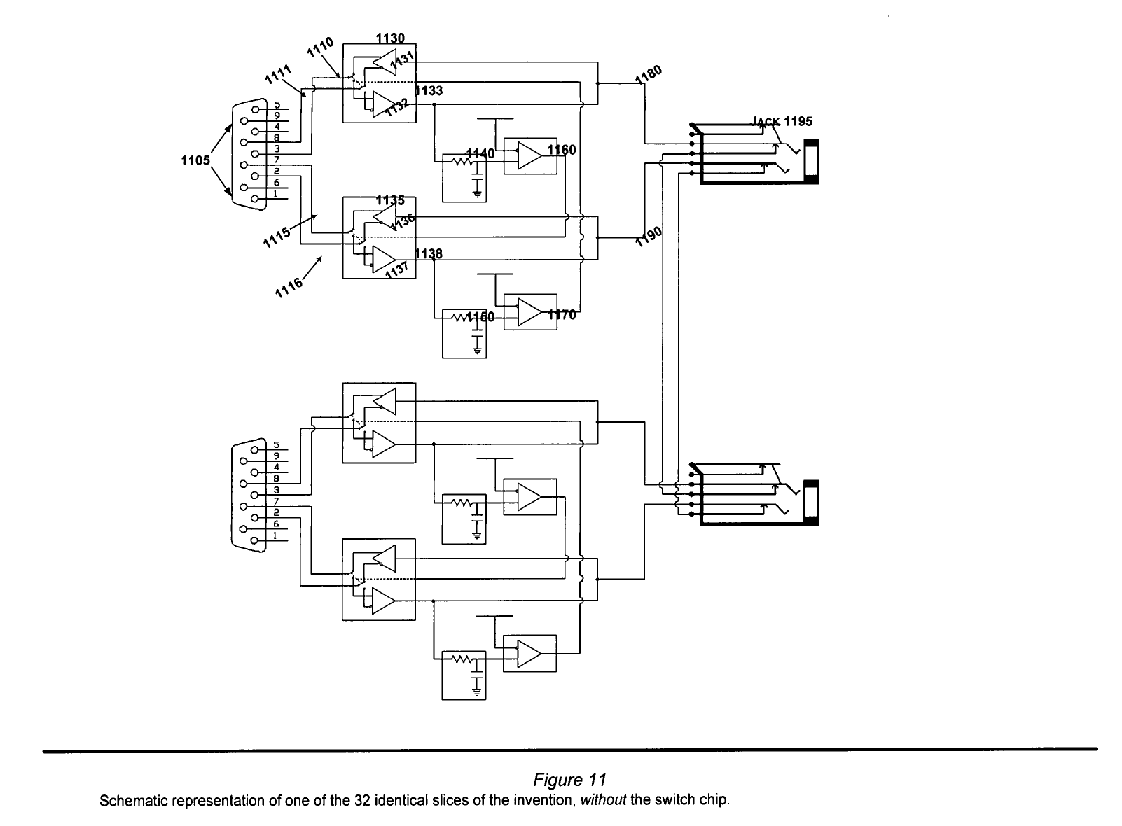

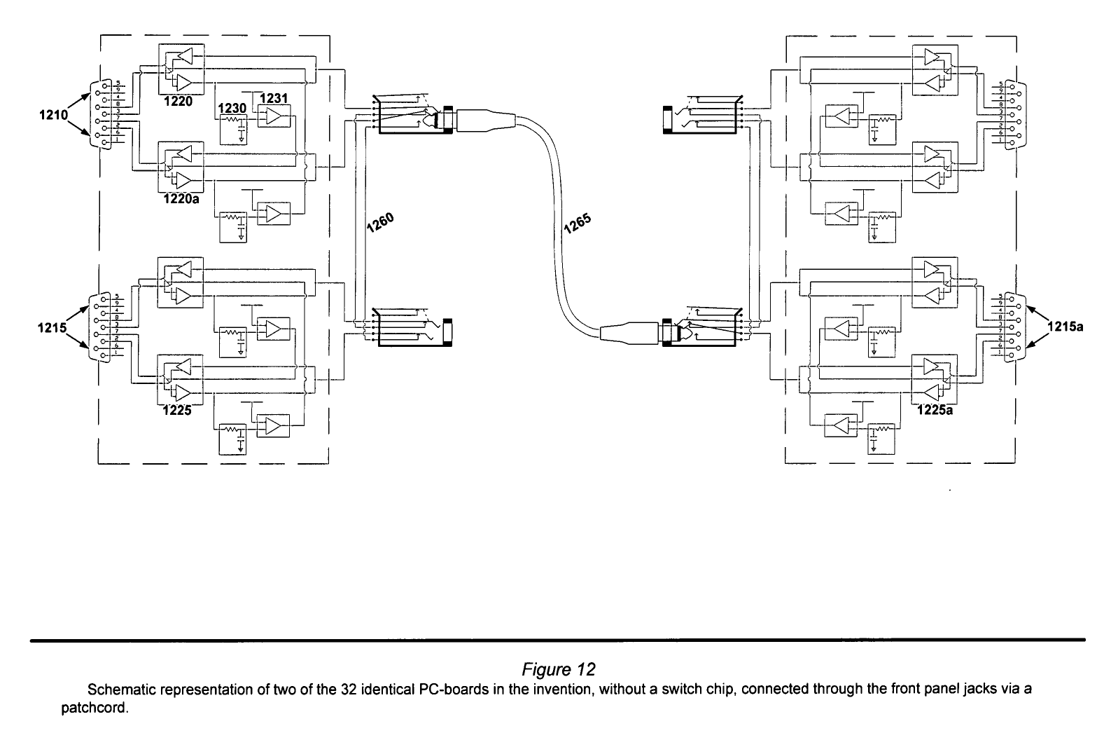

Referring to FIG. 11, in the absence of Switch Chip (1060), Averaging Circuit (1140) is always connected to Jack (1195) via Line (1180). Similarly, in the absence of Switch Chip (1065), Averaging Circuit (1150) is always connected to Jack (1195) via Line (1190). If a data signal from a device connected to another DE9 Port, not shown in FIG. 11, arrives at Jack (1195), either through a normaling connection from another jack, or through Patchcord (540) that may be plugged into Jack (1195) and another jack, this data signal will travel through Line (1180) to Averaging Circuit (1140), or through Line (1190) to Averaging Circuit (1150). If at that time RS422 Transceiver (1130) and RS422 Transceiver (1135) are still undergoing the auto-configuring process, this data signal that originated from another DE9 Port will improperly affect the determination of whether a controller or a remote is connected to DE9 Port (1105). Said determination should only be based on the RS422 signals originating from the device connected to said port. FIG. 12 illustrates the situation where there is no device connected to DE9 Port (1210) and a controller is connected to DE9 Port (1215) and to DE9 Port (1215a). Averaging Circuit (1230) is, in the absence of a switch, connected to RS422 Transceiver Chip (1225), via Normaling Connections (1260), if Patchcord (1265) is absent, or to RS422 Transceiver Chip (1225a) via Patchcord (1265), if Patchcord (1265) is present,. Once the RS422 transceivers of DE9 Ports (1215) and (1215a) have successfully completed their auto-configuration process and are appropriately configured to talk to the controllers that are connected to them, it is likely that Averaging Circuit (1230), which is associated with DE9 Port (1210), will receive signals from the controller connected to Port (1215), in the absence of Patchcord (1265), or from the controller connected to Port (1215a), otherwise. Thus Comparator Chip (1231), which is connected to the output of Averaging Circuit (1230), may erroneously configure RS422 Transceiver Chip (1220a), i.e. auto-configure Port (1210), solely due to the fact that a controller device is connected to Port (1215) or Port (1215a), even though there is nothing connected to Port (1210).

Regarding the second purpose of the switch chip, RS422 Transceiver Chip (1220a), like all transceivers, is initially configured as a receiver, before anything is plugged into DE9 Port (1210). As a receiver, it will impose a low impedance voltage on its output line. This voltage may originate in a connected controller device before the auto-configuration process is completed, and may or may not be useful information. As seen in FIGS. 11 and 12, in the absence of the switch chip, this signal from RS422 Transceiver Chip (1220a) would be sent to the RS422 Transceiver chips of other DE9 ports, e.g. RS422 Transceiver Chip (1225) through Normaling Connections (1260) of the front-panel jacks, if Patchcord (1265) is absent, or RS422 Transceiver Chip (1225a), if Patchcord (1265) is present. Thus, the invention includes switch chips, i.e. Switch Chips (1060) and (1065), for each RS422 transceiver to isolate its output from the jacks, where all of the cross-connections occur, until the auto-configuration process is successfully completed, and we thus know that said transceivers will be sending valid data.

Therefore, as shown in FIG. 10, to prevent either the contamination of the averaging circuit by transceivers of external ports, or the contamination of the transceivers of external ports by the premature sending of information by a controller, the switch is initially open. It is closed by the comparator chip when it configures the opposing transceiver chip of the same port, thus completing the port auto-configuration process.

As a further element of novelty, the invention acts to clean up the digital communications signal, i.e. reduce noise and errors, and boost its strength and integrity, by regenerating it. Over time and distance, a signal is subject to degradation for a variety of reasons, including, but not limited to noise, parasitic electric and magnetic field coupling, and voltage spikes. However, as long as a usable digital signal is received by the powered patchbay, i.e. where the previous ills do not cause reception errors, the signal output of the transceiver will be a new, fresh signal, free of the degradation of distance and time. Thus, the output signal of the powered patchbay will be approximately the same quality as the output signal of the origination device (a controller or a remote). In contrast, the output signal of a traditional, unpowered patchbay is no better in terms of strength and quality than the signal entering the patchbay, and is often in fact distorted, due to the impedance mismatch and parasitic inductance of the switching jacks, cables and other parts.

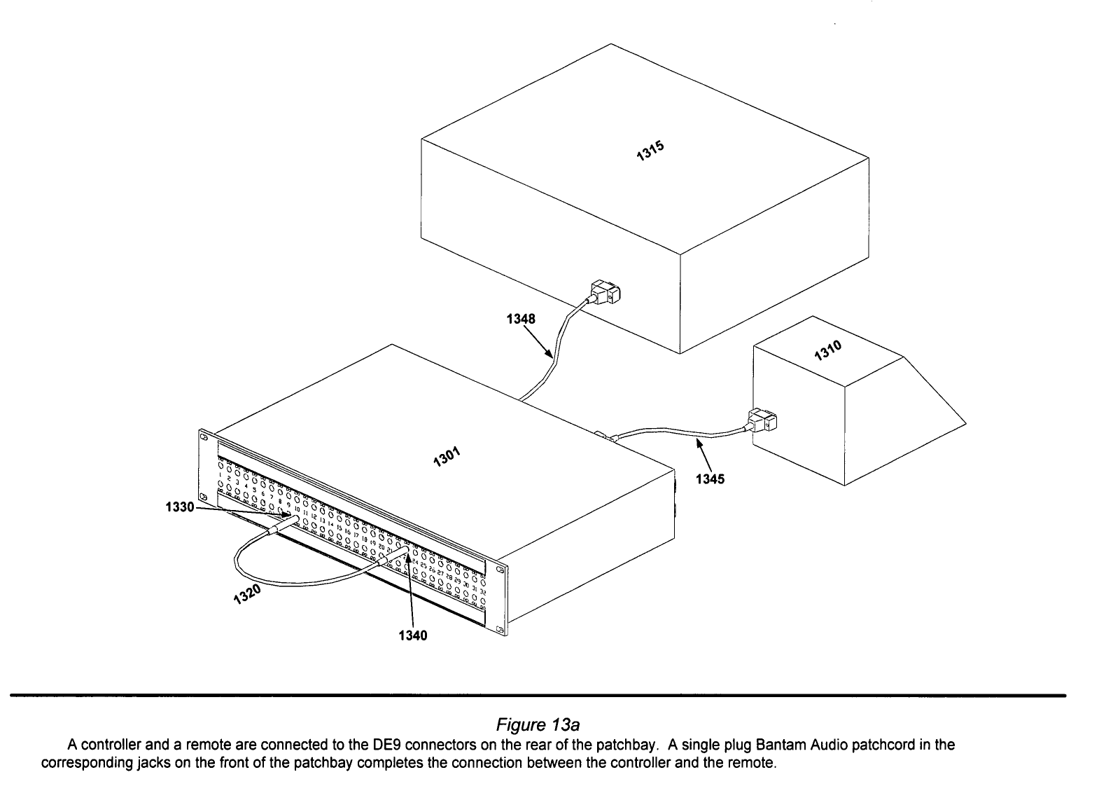

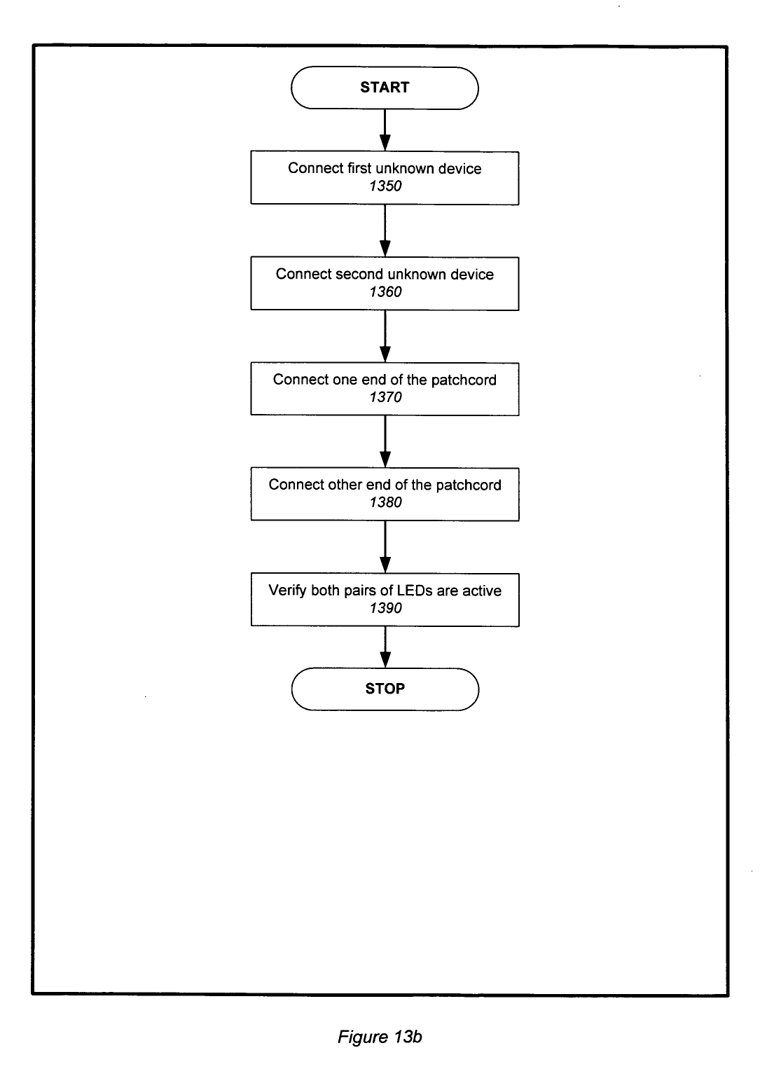

Referring to FIG. 13a, FIG. 13a illustrates an example of two devices connected to the invention, which provides bidirectional communications between these devices, via a patchcord. Unknown Device (1310) and (1315) are each connected to Patchbay (1301) via DE9 Cables (1345) and (1348). Remote Delegation Protocol Data, i.e. commands and responses, are exchanged between the two devices, which are connected via Patchcord (1320), which is inserted into Jacks (1330) and (1340). Thus, if Unknown Device (1310) is a controller and Unknown Device (1315) is a remote, then Controller (1310) will control the operation of Remote (1315).

Referring to FIG. 13b, FIG. 13b illustrates a high-level flow diagram of the invention in operation. At step 1350, Unknown Device (1310) is plugged into a DE9 port on the rear panel of Patchbay (1301). At step 1360, Unknown Device (1315) is connected to another DE9 port on the rear panel of Patchbay (1301). At step 1370 Patchcord (1320) is inserted into Jack (1330), which corresponds to the first rear panel DE9 port. At step 1380 the other end of Patchcord (1320) is inserted into Jack (1340), which corresponds to the second rear panel DE9 port. If Unknown Devices (1310) and (1315) are communicating correctly, the corresponding pairs of LEDs will blink.

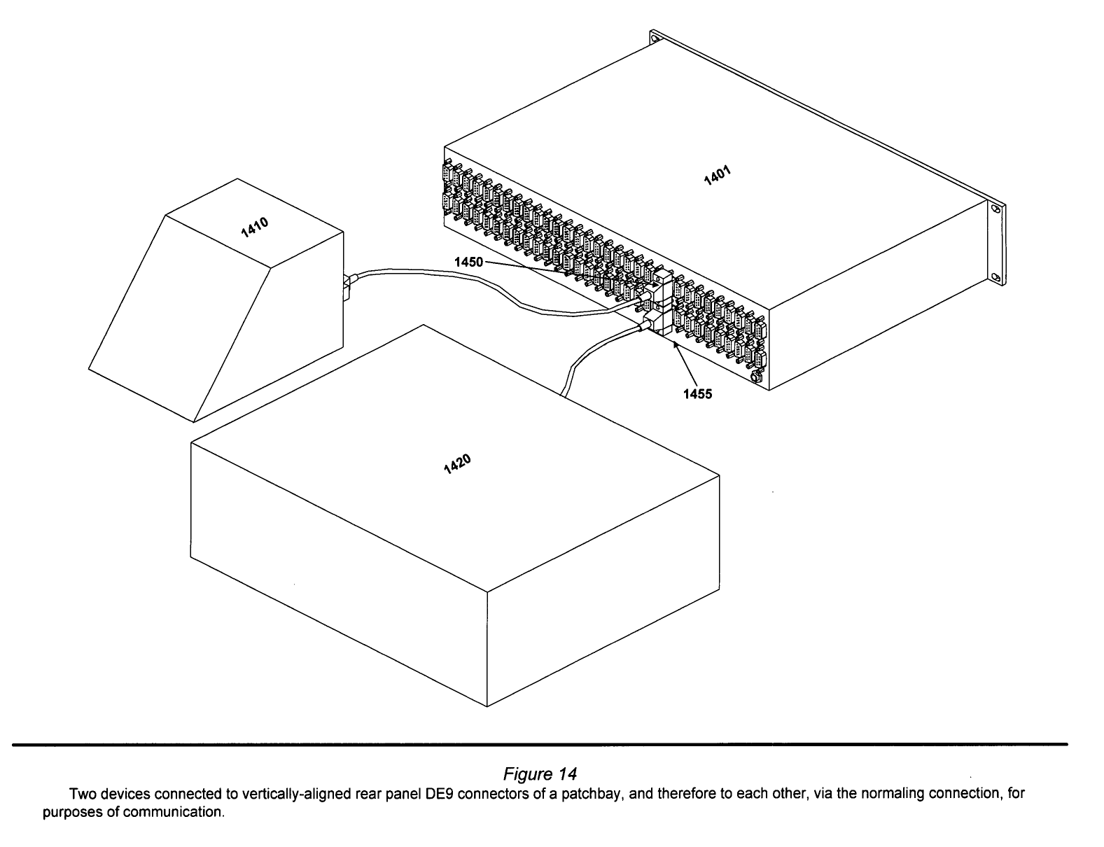

Referring to FIG. 14, FIG. 14 illustrates an example of two devices, i.e. Unknown Devices (1410) and (1420), connected to vertically aligned DE9 Connectors (1450) and (1455) on the rear panel of Patchbay (1401), and hence also connected to each other for the purposes of remote operations, without a patchcord being inserted into the corresponding front panel jacks.

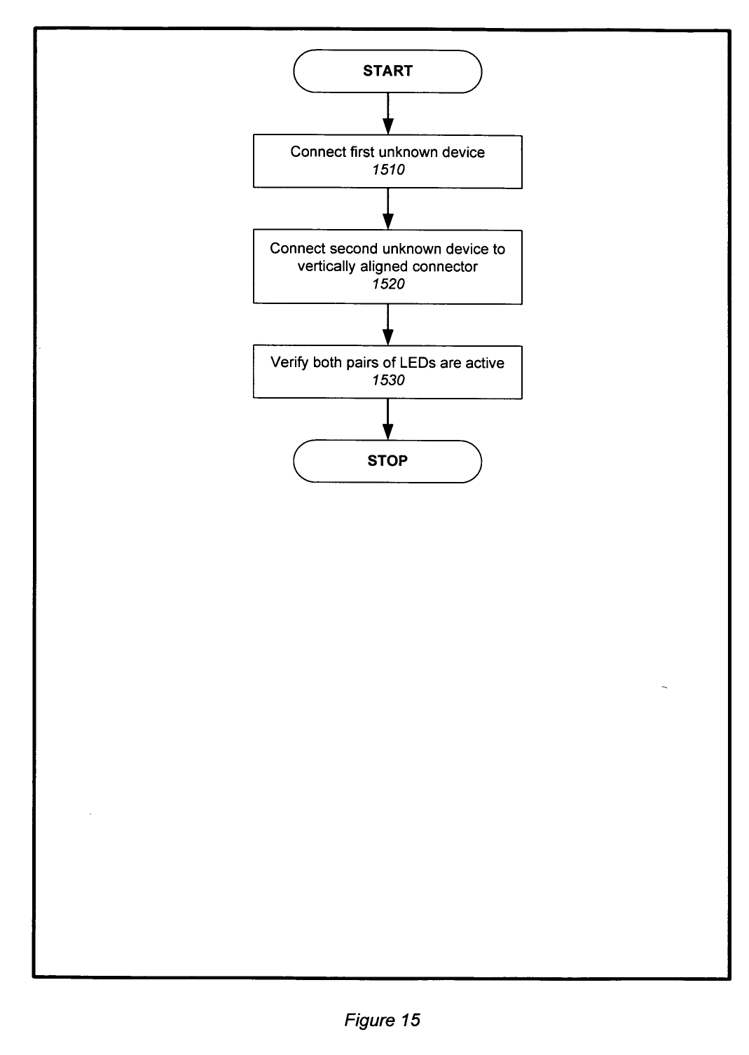

Referring to FIG. 15, FIG. 15 illustrates a high-level flow diagram of connecting two devices to vertically aligned DE9 connectors of the invention. At step 1510, Unknown Device (1410) is plugged into DE9 Port (1450). At Step 1520, Unknown Device (1420) is plugged into DE9 Port (1455) which is vertically aligned with DE9 Port (1450). In the absence of an inserted patchcord in the corresponding front panel jacks, Unknown Devices (1410) and (1420) will be connected, enabling one device to control the other, because DE9 Ports (1450) and (1455) are vertically aligned, and hence connected by default by the normaling connection. If Unknown Devices (1410) and (1420) are communicating properly, the corresponding pairs of LEDs will blink.

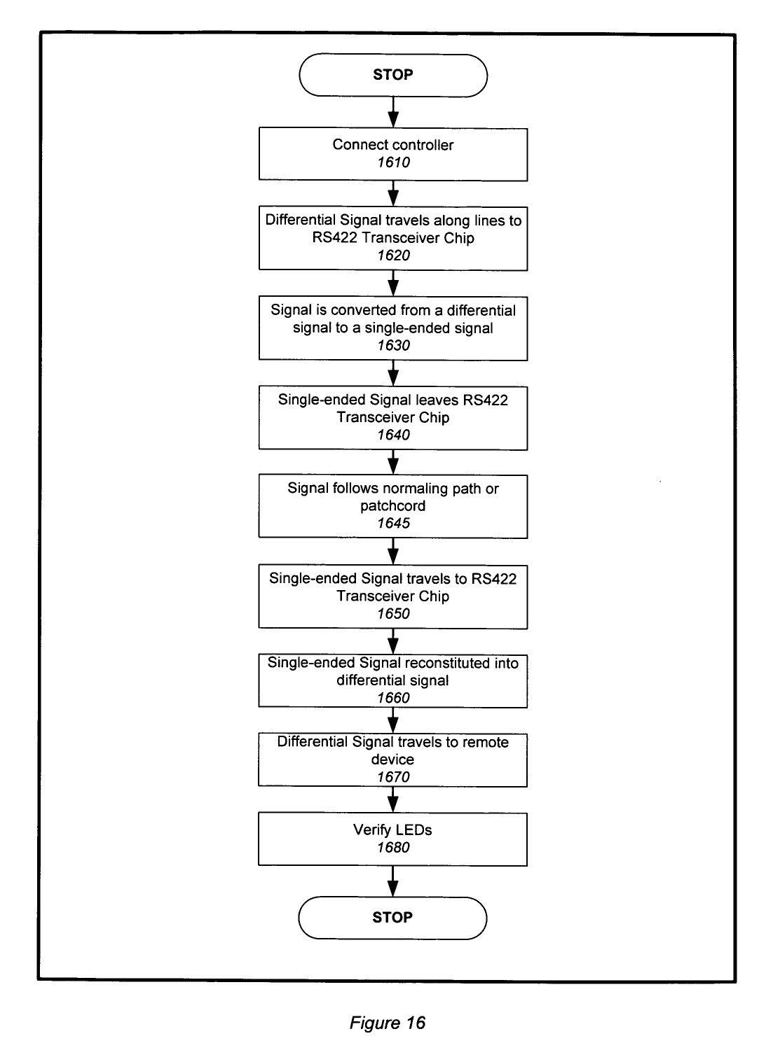

Referring to FIG. 16, FIG. 16 illustrates a high-level flow diagram of the signal path through the invention. At step 1610 Controller (720) is connected to DE9 Port (905). Similarly, Remote (730) is connected to DE9 Port (995). At Step 1620 Controller (720) sends out a differential signal which travels along Lines (925) and (920) to RS422 Transceiver Chip (940), where at step 1630 the signal is converted from a differential signal to a single-ended signal which, at step 1640, is carried on one wire, Line (951). The signal arrives at Jack (955). At step 1645, the signal follows the closed circuit created either by Patchcord (540), if inserted into Jacks (955) and (956), or through Normaling Connections (957), in the absence of Patchcord (540). At Step 1650, the signal continues on Line (952), where it reaches RS422 Transceiver Chip (990), where at step 1660 it is reconstituted into a differential signal which, at step 1670, arrives at Remote (730) on Lines (970) and (975). If the signal travels the complete circuit described above, LEDs (991), (992), (993), and (994) will blink at step (1680).

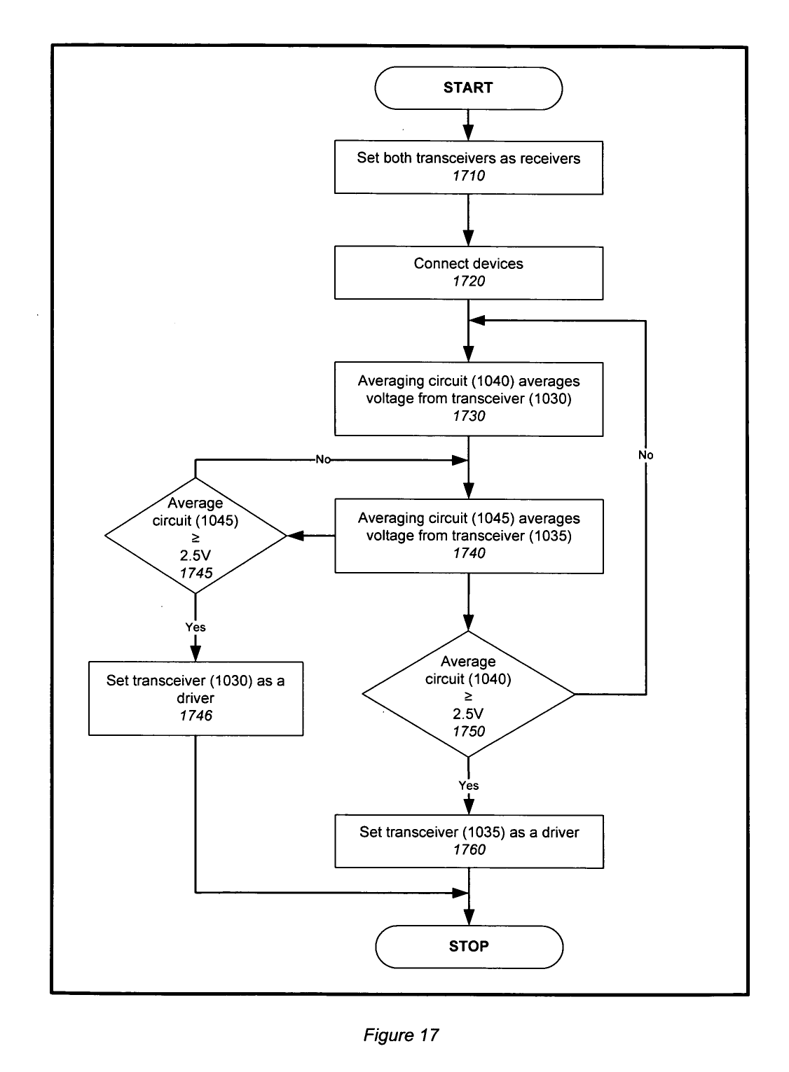

Referring to FIG. 17, FIG. 17 illustrates a high-level flow diagram of the method of determining whether an unknown device connected to the rear panel DE9 connectors is a controller device or a remote device. At step 1710 both RS422 Transceivers (1030) and (1035) are initially configured as receivers, in the absence of a device connected to DE9 Connector (1005). Unknown Device (1001) is connected to DE9 Connector (1005) at step 1720. At steps 1730 and 1740 Averaging Circuits (1040) and (1045) average the output voltage of RS422 Transceiver Chips (1030) and (1035), respectively. At steps 1745 and1750 a decision is made: Comparator Chips (1050) and (1055) each compare the output of Averaging Circuits (1040) and (1045) respectively to +2.5 Volts. If the output of Averaging Circuit (1040) is greater than +2.5 Volts, then at step 1760 Comparator Chip (1050) sets RS422 Transceiver Chip (1035) as a driver. If the output of Averaging Circuit (1045) is greater than +2.5 Volts, then at step 1745, Comparator Chip (1055) sets RS422 Transceiver Chip (1030) as a driver.

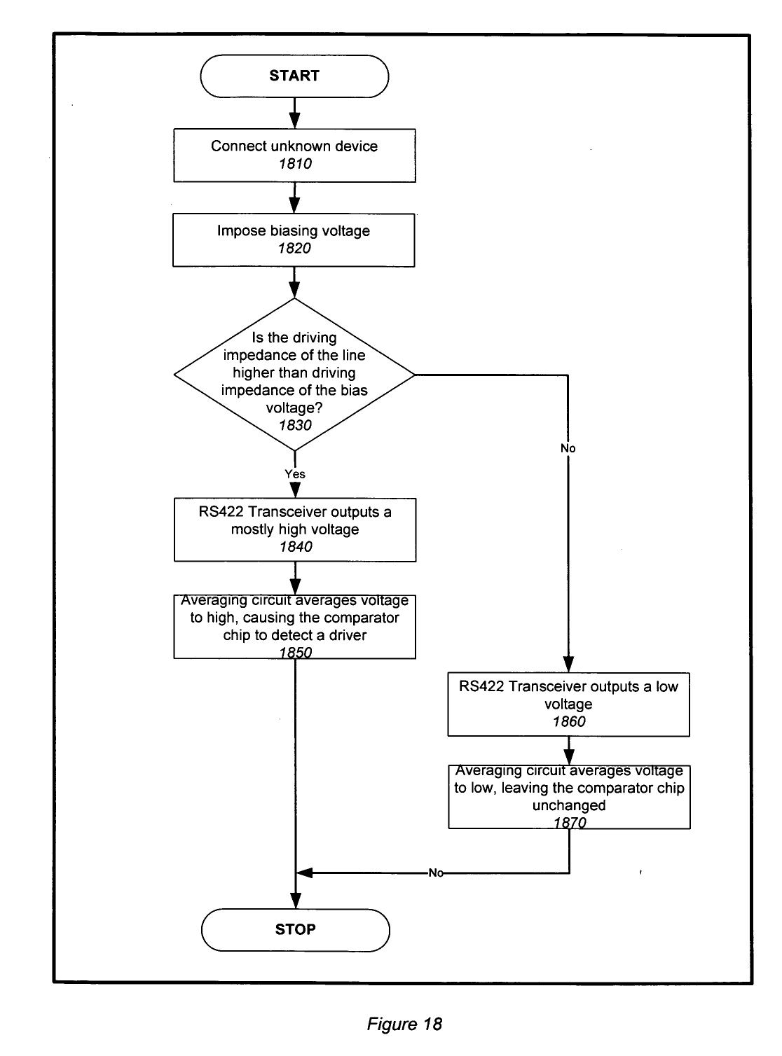

Referring to FIG. 18, FIG. 18 illustrates a high-level flow diagram of a method of preventing a receiver of another device from imposing a parasitic voltage on the input lines of the invention, thus being inadvertently misidentified as a driver. At step 1810, Unknown Device (1001) is connected to DE9 Port (1005). At step 1820 Biasing Circuit (1020) imposes a low negative voltage (−5 Volts) on Lines (1010) and (1011). This voltage has an impedance of 1000 Ohms. At step 1830 one of two things happens. If the voltage imposed by Biasing Circuit (1020) has higher impedance than the voltage imposed by Unknown Device (1001), which will be the case if the imposed voltage is from a legitimate driver, then at step 1840 RS422 Transceiver Chip (1030) will only consider the voltage from Unknown Device (1001). Furthermore, at step 1840, this voltage will be translated by RS422 Transceiver Chip (1030) into a mostly logic high (+5 Volts) single-ended voltage, which at step 1850 will ultimately be averaged to +5 Volts by Averaging Circuit (1040) and change the output of Comparator Chip (1050), appropriately configuring RS422 Transceiver Chip (1035) as a driver. If, however, the voltage imposed by Biasing Circuit (1020) has lower impedance than the voltage imposed by Unknown Device (1001), which will be the case if the imposed voltage is a parasitic voltage from a receiver, then at step 1860 RS422 Transceiver Chip (1030) will remain unaffected by the parasitic voltage, and only consider the voltage from Biasing Circuit (1020). At step 1870 this voltage will be translated by RS422 Transceiver Chip (1030) into a logic low (0 Volts) single-ended voltage, which will ultimately be averaged to 0 Volts by Averaging Circuit (1040), which means that the output of Comparator Chip (1050) will remain unchanged at 0 Volts, and RS422 Transceiver Chip (1035) will remain configured as a receiver. Hence, the parasitic input voltage will not result in any configuration changes, i.e. will be appropriately ignored.

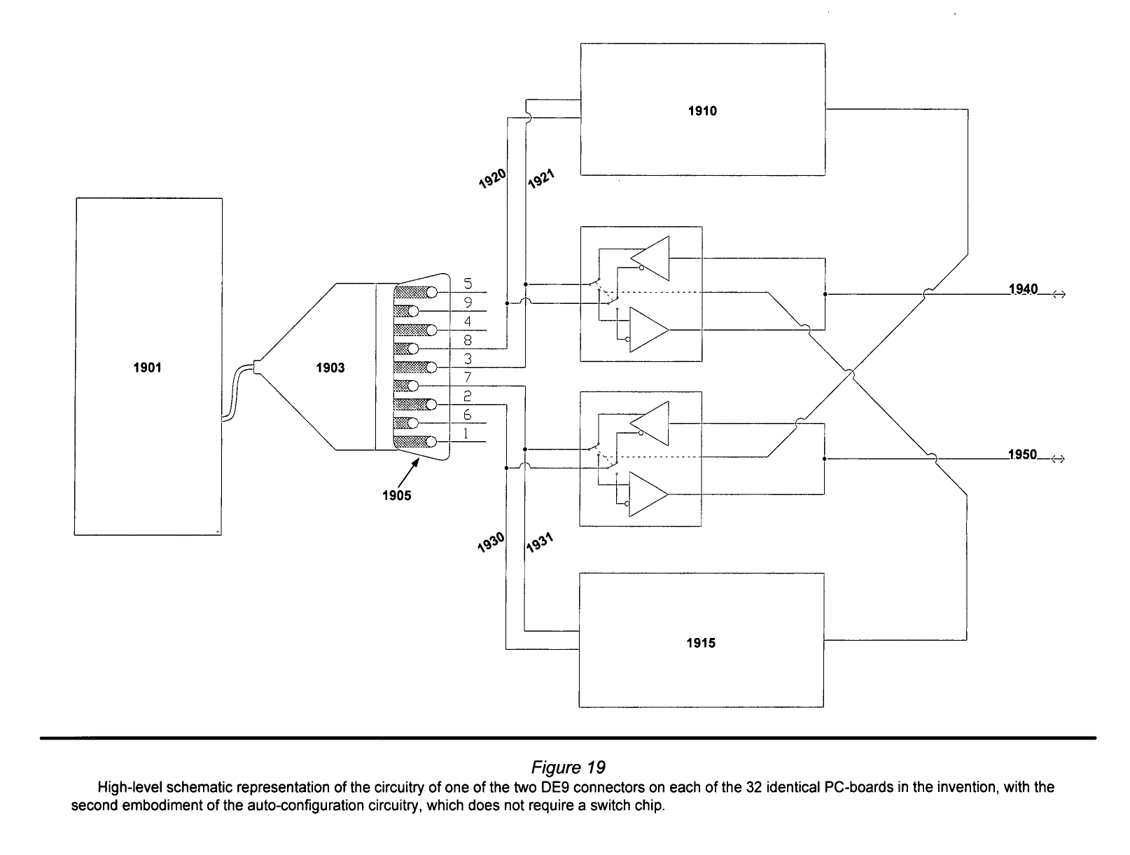

The invention also admits a second embodiment of the auto-configuration circuitry, in which the data transmission circuitry, hereinafter referred to as the “data channel,” is separated from the auto-configuration circuitry. As in the first embodiment, the auto-configuration circuitry determines whether Unknown Device (1901), shown in FIG. 19, is a Controller (720) or a Remote (730) and auto-configures the RS422 transceiver chips of DE9 Port (1905) accordingly.

Referring to FIG. 19, FIG. 19 is an abstract drawing illustrating the second embodiment of the auto-configuration circuitry, and particularly the absence of a switch chip. This second embodiment of the auto-configuration circuitry is different from the first embodiment in that it creates separate data transmission channels, which are completely independent and electrically isolated from the auto-configuration circuitry. As shown in FIG. 19, Auto-Configuration Circuitry (1910) and (1915) are both permanently electrically isolated from all data signals that are exchanged via the front panel jacks, which are carried by Lines (1940) and (1950), thus eliminating the need for a switch chip. More specifically, Auto-Configuration Circuitry (1910) and (1915) are each only affected by the voltages imposed on Lines (1920) and (1921) and Lines (1930) and (1931), respectively, by Unknown Device (1901) connected to DE9 Port (1905).

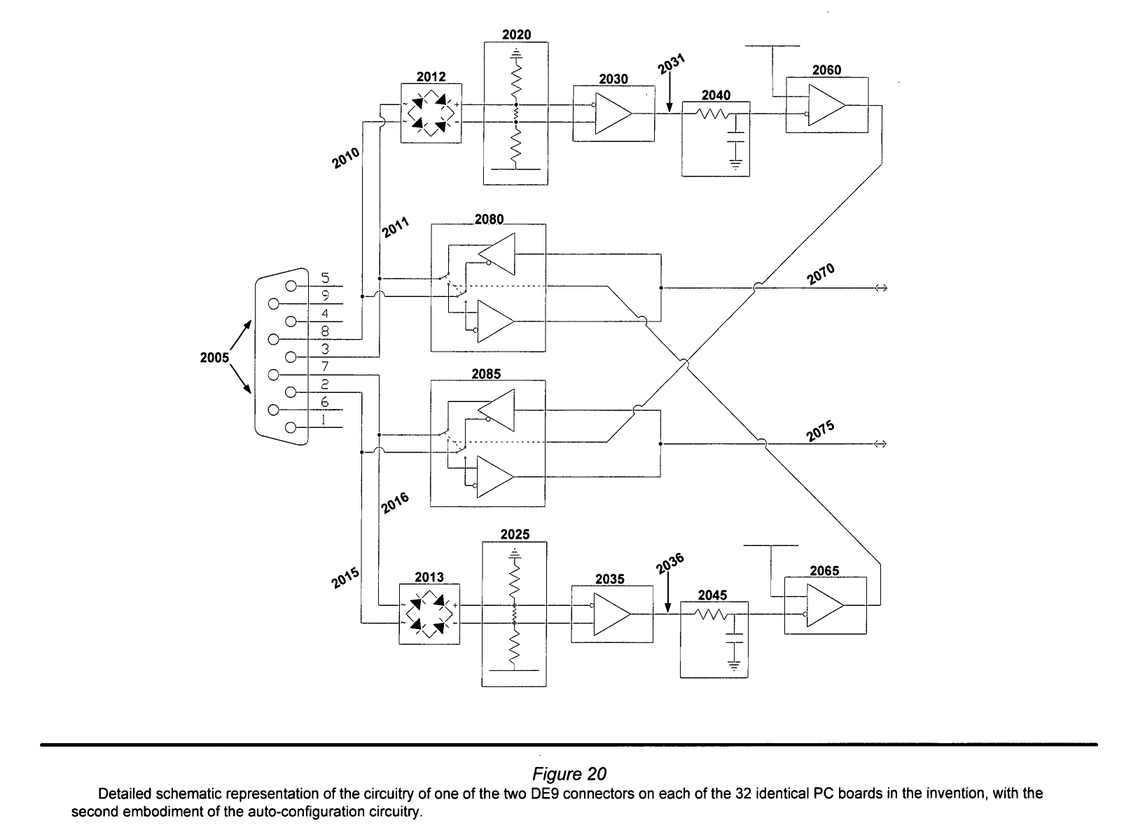

Referring to FIG. 20, FIG. 20 is a more detailed schematic drawing of this second embodiment of the auto-configuration circuitry. RS422 Transceiver Chips (2080) and (2085) are both configured as receivers in the absence of a device connected to DE9 Port (2005). When Controller (720) is attached to DE9 Port (2005), it imposes a low impedance voltage on Pins (8) and (3) of DE9 Port (2005), via its communication signal. This communication signal is carried on Lines (2010) and (2011). The voltage of this differential, RS422-compliant signal is either a +5 Volts or a −5 Volts, with quick transitions between these two voltage levels. Diode Bridge Rectifier (2012), also known as Rectifier (2012), converts negative voltages at its input into positive voltages of the same magnitude at its output, so it converts the communication signal at its input into a constant +5 Volt signal, with quick downward spikes to 0 Volts, when the said input signal transitions from +5 Volts to −5 Volts and vice-versa. Since this communication voltage has lower impedance than the voltage imposed by Biasing Circuit (2020), the communication voltage will swamp out, i.e. dominate over, Biasing Circuit's (2020) voltage, as previously described in the first embodiment of the auto-configuration circuitry. RS422 Receiver (2030) converts the differential signal into a single-ended signal, which is carried on one line, Line (2031). This converted signal on Line (2031) is a signal of primarily 0 Volts, with short duration spikes of +5 Volts. Filter (2040) removes the voltage spikes, outputting a clean 0 Volt signal. RS422 Receiver (2060) inverts the voltage of this signal, outputting a voltage of +5 Volts. This +5 Volt signal sets the D/ R̅ Select Pin of Transceiver (2085) to +5 Volts (high), which causes RS422 Transceiver Chip (2085) to be appropriately configured as a driver, since it is now ready to transmit the responses of Remote (730), which is connected to another DE9 port, back to Controller (720).

Ideally, Controller (720) should not impose a voltage on Pins (7) and (2) of DE9 Port (2005), which are connected to Lines (2015) and (2016), because Controller (720) is only supposed to receive the response of Remote (730) on those pins. Nevertheless, as previously explained, some Controllers (720) do impose a parasitic voltage on those pins. This voltage, being a parasitic voltage, is a high impedance voltage. As before, Rectifier (2013) converts this parasitic voltage into a constant positive voltage. Biasing Circuit (2025), however, imposes a lower impedance negative voltage on Lines (2015) and (2016), which prevails over the parasitic voltage. Thus RS422 Receiver (2035) only “sees” the negative voltage of Biasing Circuit (2035), and ignores the parasitic voltage of the RS422 receiver of Controller (720). RS422 Receiver (2035) converts this differential voltage into a single-ended voltage of +5 Volts. Filter (2045) removes any remaining voltage spikes, leaving a “clean” +5 Volt signal. RS422 Receiver (2065) inverts this voltage, outputting a signal of 0 Volts, which sets the D/ R̅ Select Pin of Transceiver (2080) to 0 Volts (low), which appropriately leaves RS422 Transceiver Chip (2080) configured as a receiver. Thus, RS422 Transceiver Chip (2080) has been appropriately configured as a receiver, i.e. it will receive information from Controller (720) via Pins (8) and (3). Also, as explained above, RS422 Transceiver Chip (2085) has been configured as a driver, i.e. it will transmit the response of a remote device to Controller (720) via Pins (7) and (2). If a Remote (730) had been connected to DE9 Port (2005), the auto-configuration process would proceed in an analogous way, with RS422 Transceiver Chip (2080) being configured as a driver and RS422 Transceiver Chip (2085) being configured as a receiver.

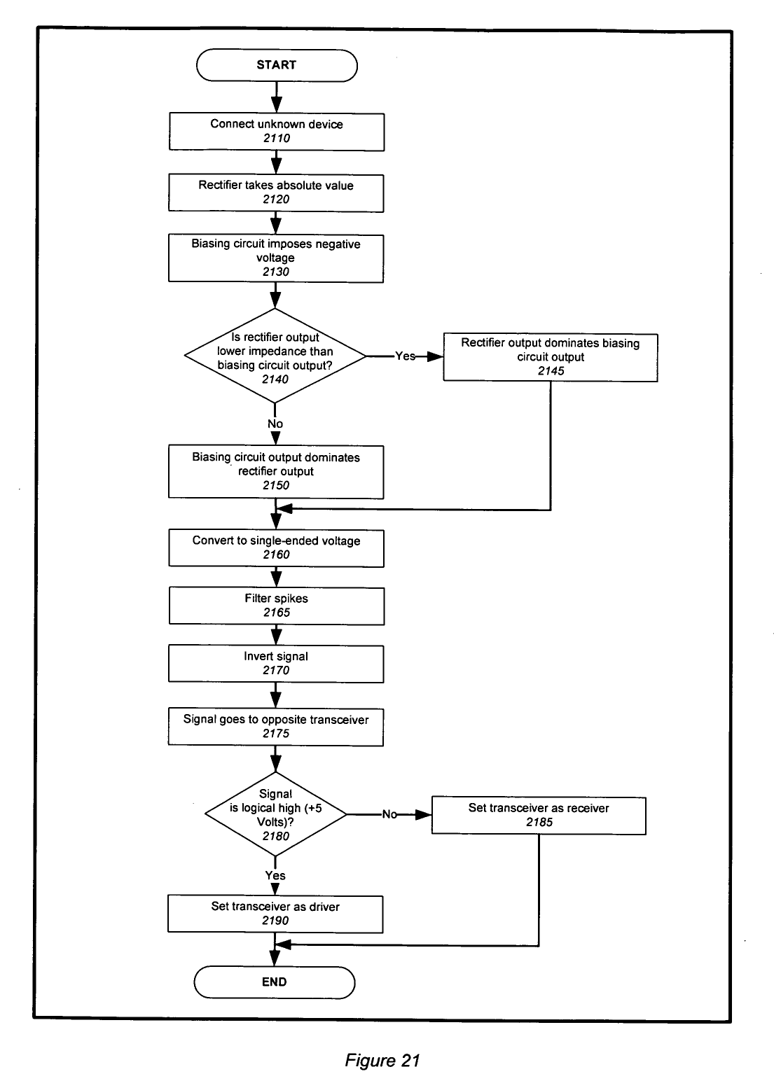

FIG. 21 illustrates a high-level flow diagram of the invention using the second embodiment of the auto-configuration circuitry. At step 2110 an unknown device is connected to DE9 Port (2005) of the invention. At Step 2120, Rectifier (2012) takes the absolute value of the voltage imposed on lines (2010) and (2011), i.e. it converts this voltage into a positive voltage of the same magnitude. At Step 2130, Biasing Circuit (2020) attempts to impose a negative voltage on the input lines of RS422 Receiver (2030). At step 2140, if the output voltage of Rectifier (2012) has lower impedance than the output voltage of Biasing Circuit (2020), the output voltage of Rectifier (2012) will dominate the input of RS422 Receiver (2030) at step 2145. Conversely, if at step 2140 the output voltage of Biasing Circuit (2020) has lower impedance than the output voltage of Rectifier (2012), then at step 2150 the output voltage of Biasing Circuit (2020) will dominate the input of RS422 Receiver (2030).

At step 2160, RS422 Receiver (2030) converts its input voltage into a single-ended (TTL) output voltage. At step 2165, Filter (2040) removes any spikes from this voltage. At step 2170, RS422 Receiver (2060) inverts the voltage, i.e. converts +5 Volts into 0 Volts, and vice-versa. At step 2175, the signal proceeds to the D/ R̅ Select Pin of RS422 Transceiver Chip (2085), which is initially configured as a receiver in the absence of a device connected to DE9 Port (2005). If this signal, at step 2180, has a logic low voltage (0 Volts), then RS422 Transceiver Chip (2085) remains configured as a receiver at step 2185. Conversely, if this signal at step 2180 has a logic high voltage (+5 Volts), then RS422 Transceiver Chip (2085) is configured as a driver.

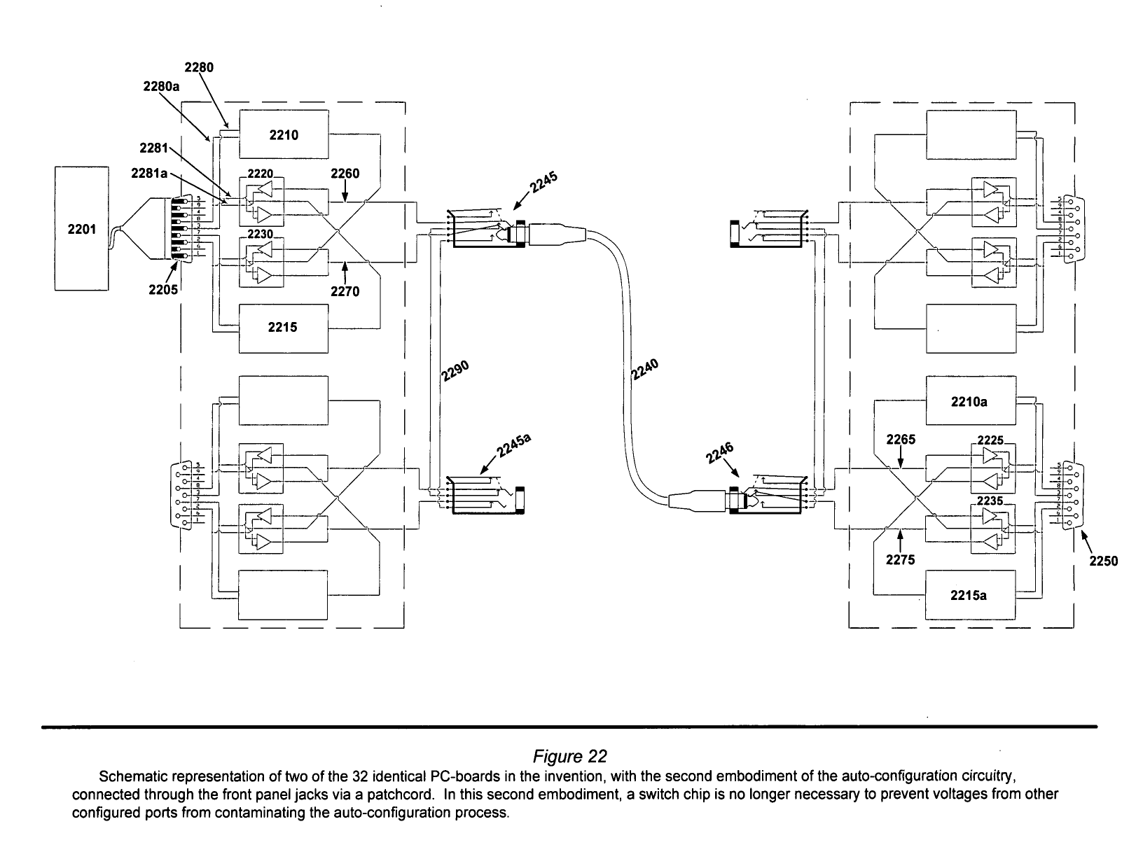

Referring to FIG. 22, FIG. 22 is a high-level abstract diagram of two PC-boards of the invention connected via a patchcord, intended to illustrate that in this second embodiment of the auto-configuration circuitry, a switch chip is no longer needed to prevent voltages from other configured ports from contaminating the auto-configuration process. While no controller or remote devices are connected to DE9 Connectors (2205) and (2250), RS422 Transceivers (2220), (2230), (2225), and (2235) are configured as receivers. As receivers, they will not accept signals from Lines (2260), (2270), (2265), and (2275).

As described herein, if Unknown Device (2201), connected to DE9 Connector (2205), is Controller (720), then it imposes its communication voltage, which is a hailing signal that varies between +5 and −5 Volts, on Lines (2280) and (2280a), which carry this signal to Auto-Configuration Circuitry (2210). Lines (2281) and (2281a) are connected to Lines (2280) and (2280a), so the same hailing signal will also be imposed on Lines (2281) and (2281a), which are part of the newly separated data channel. This hailing signal will be converted from a differential signal to a single-ended signal by RS422 Transceiver (2220) and either exit the powered patchbay via Line (2260) and Jack (2245) into Patchcord (2240), or will travel to vertically aligned front panel Jack (2245a) via Normaling Connection (2290), in the absence of Patchcord (2240). If Patchcord (2240) is present, the signal travels along Patchcord (2240), through Jack (2246), to Line (2265), and reaches RS422 Transceiver (2225). If RS422 Transceiver (2225) has already been configured as a driver, then it will take this hailing signal, convert it to a differential RS422 signal and transmit it to DE9 Port (2250). It should be noted that, regardless of whether RS422 Transceivers (2225) and (2235) of DE9 Port (2250) have been auto-configured, the communications voltage of the hailing signal of Controller (720) connected to DE9 Port (2205) can never reach Auto-configuration Circuits (2210a) and (2215a), and thus no contamination of the auto-configuration process is possible, thereby eliminating the need for the switch chip, which served to isolate the auto-configuration circuitry in its first embodiment.

We claim:

1. An exemplary, powered switching station, also known as a powered patchbay, configured to route electronic communication signals from a first electronic device to a second electronic device, each device being capable of bidirectional communications, said powered patchbay comprising:
a. A first electrical connector for transmitting and receiving electronic communication signals to and from said first electronic device;
b. A second electrical connector for transmitting and receiving electronic communication signals to and from said second electronic device;
c. A first printed circuit board configured to receive a differential electronic communication signal from the first electronic device, convert said differential signal into a single-ended signal, and transmit said single-ended signal to a second printed circuit board;
d. Said second printed circuit board configured to receive said single-ended signal from said first circuit board, convert said single-ended signal into a differential signal, and transmit said differential signal to said second electronic device;
e. A first jack configured to receive said single-ended signal from said first circuit board; and
f. A second jack configured to transmit said single-ended signal to said second circuit board.

2. The first electronic device of claim 1, where the electronic device is configured to act as a controller.

3. The second electronic device of claim 1, where the electronic device is configured to be controlled by a controller, i.e. is configured to act as a remote.

4. The printed circuit boards of claim 1, where the printed circuit boards each comprise one or more input biasing circuits, one or more transceivers, and auto-configuration circuitry.

5. The auto-configuration circuitry of claim 4, comprising one or more averaging circuits, where said averaging circuits are configured to average the voltage received from the transceivers; one or more comparators, where the comparators are configured to compare the output voltage of the averaging circuits with a predetermined value; one or more switches, where the switches are configured to isolate the auto-configuration circuitry to prevent transceivers from prematurely sending information to the transceivers of other ports, via the jacks, and to prevent such received information from affecting the auto-configuration of other ports.

6. The input biasing circuits of claim 4, where said input biasing circuits are configured to prevent parasitic receiver voltages from being received by said transceivers and corrupting the auto-configuration process, by imposing a negative mid-impedance voltage, said voltage having a higher impedance that a legitimate driver voltage and a lower impedance than a parasitic receiver voltage.

7. The transceivers of claim 4, where said transceivers are configured to act as receivers and convert said differential electric signals into said single-ended electric signals.

8. The transceivers of claim 4, where said transceivers are configured to act as drivers and convert said single-ended electric signals into said differential signals.

9. The first comparator of claim 5, where said comparator sets the D/ R̅ Select pin of the second transceiver to a logic high voltage, whenever the output of the first averaging circuit exceeds a predetermined value.

10. The second comparator of claim 5, where said comparator sets the D/ R̅ Select pin of the first transceiver to a logic high voltage, whenever the output of the second averaging circuit exceeds a predetermined value.

11. The comparators of claim 5, where each comparator is configured to close a switch, whenever the output of the averaging circuit exceeds a predetermined value.

12. The powered patchbay of claim 1, further comprising one or more LED pairs configured to activate whenever the electronic devices connected to the patchbay are communicating properly.

13. The printed circuit boards of claim 1, where the circuit boards comprise one or more transceivers, and auto-configuration circuitry.

14. The transceivers of claim 13, where said transceivers are configured to acts as receivers and convert said differential electric signal into said single-ended electric signal.

15. The transceivers of claim 13 where said transceivers are configured to act as drivers and convert said single-ended electric signal into said differential electric signal.

16. The auto-configuration circuitry of claim 13, where said auto-configuration circuitry comprises one or more rectifiers, one or more input biasing circuits, a first and second receiver, and one or more filters.

17. The rectifier of claim 16, where the rectifier is configured to convert negative voltages of the differential signal imposed by the electronic device into positive voltages of equal magnitude, but leaves positive voltages unchanged.

18. The input biasing circuits of claim 16, where said input biasing circuits are configured to prevent parasitic receiver voltages from being received by said transceivers and corrupting the auto-configuration process, by imposing a negative mid-impedance voltage, said voltage having a higher impedance that a legitimate driver voltage and a lower impedance than a parasitic receiver voltage.

19. The first receiver of claim 16, which is configured to convert the output of the input biasing circuit into a single-ended signal.

20. The filters of claim 16, where said filters are configured to filter the output voltage of the first receiver and remove any extant voltage spikes.

21. The second receiver of claim 16, where said receiver is configured to invert the output voltage of the filter.

22. The second receiver of claim 21, where said receiver further sets the D/ R̅ Select pin of the opposing transceiver of the data channel to a logic high voltage, whenever the output from the filter is a logic low voltage.

23. The auto-configuration circuitry of claim 13, where the auto-configuration circuitry is separated from the data transmission circuitry.

24. The jacks of claim 1, where said jacks are standard, Single Bantam Audio (TT) jacks, with which patchcords with single-head Bantam Audio (TT) plugs are used.

25. A method of routing electronic communication signals from a first electronic device to a second electronic device comprising the steps of:
a. Connecting a first electronic device to a first communications port of a powered switching station also known as a powered patchbay;
b. Connecting a second electronic device to a second communications port of said powered patchbay;
c. Routing a first differential communications signal from the first electronic device, via the first communications port, to a first transceiver of said powered patchbay;
d. Routing a second differential communications signal from the second electronic device, via the second communications port, to a second transceiver of said powered patchbay;
e. Converting said first differential communications signal into a first single-ended signal;
f. Converting said second differential communications signal into a second single-ended signal;
g. Routing said first single-ended signal to the first transceiver of the second communications port, which is configured to act as a driver;
h. Routing said second single-ended signal to the second transceiver of the first communications port, which is configured to act as a driver;
i. Reconstituting said first single-ended signal in to the first differential signal and transmitting said first differential signal to the second electronic device; and
j. Reconstituting said second single-ended signal into the second differential signal and transmitting said second differential signal to the first electronic device.

26. The electronic devices of claim 25, where each electronic device is capable of remote communications with another device via an RS422 compliant communications port.

27. The single-ended signals of claim 25, where each single-ended signal is a TTL signal.

28. The single-ended signals of claim 25, where each single-ended signal is an RS232 signal.

29. The method of claim 25 further comprising the step of auto-configuring the transceivers of each port, comprising the steps of a. Routing a first single-ended signal to a first averaging circuit, said single-ended signal being the output signal from a first transceiver;
b. Routing a second single-ended signal to a second averaging circuit, said single-ended signal being the output signal from a second transceiver;
c. Averaging the voltage of the first single-ended signal, said voltage averaging being accomplished by the first averaging circuit;
d. Averaging the voltage of the second single-ended signal, said voltage averaging being accomplished by the second averaging circuit;
e. Routing the output voltage of the first averaging circuit to a first comparator, where the value of said output voltage is compared with a pre-determined voltage value;
f. Routing the output voltage of the second averaging circuit to a second comparator, where the value of said output voltage is compared with a pre-determined voltage value;
g. Setting the D/ R̅ select pin of the second transceiver, to configure said second transceiver as a driver or a receiver, based on the output voltage of the first comparator; and
h. Setting the D/ R̅ select pin of the first transceiver, to configure said first transceiver as a driver or a receiver, based on the output voltage of the second comparator.

30. The method of claim 29 further comprising the step of biasing the input of the first and the second transceiver with mid-impedance, negative voltages from a first and second input biasing circuit.

31. The method of claim 29, where the pre-determined voltage value is half the supply voltage of the powered patchbay.

32. The method of claim 25 further comprising the step of auto-configuring the transceivers of each port, comprising the steps of
a. Routing a first differential signal to a first diode bridge rectifier, which converts the negative voltages of said differential signal into positive voltages of equal magnitudes, while leaving the positive voltages of said differential signal unchanged;
b. Routing a second differential signal to a second diode bridge rectifier, which converts the negative voltages of said differential signal into positive voltages of equal magnitudes, while leaving the positive voltages of said differential signal unchanged;
c. Biasing the output of the first rectifier with a mid-impedance, negative voltage from a first biasing circuit;
d. Biasing the output of the second rectifier with a mid-impedance, negative voltage from a second biasing circuit;
e. Routing the output differential signal of the first biasing circuit to a first receiver, which converts said differential signal into a single-ended signal;
f. Routing the output differential signal of the second biasing circuit to a second receiver, which converts said differential signal into a single-ended signal;
g. Routing the single-ended output signal of the first receiver to a first filter, which filters out any spikes of said output signal;
h. Routing the single-ended output signal of the second receiver to a second filter, which filters out any spikes of said output signal;
i. Routing the single-ended output signal of the second filter to a third receiver, which inverts the voltage of said signal;
j. Routing the single-ended output signal of the second averaging filter to a fourth receiver, which inverts the voltage of said signal;
k. Setting the D/ R̅ select pin of the second transceiver, to configure said second transceiver as a driver or a receiver, based on the output voltage of the third receiver; and
l. Setting the D/ R̅ select pin of the second transceiver, to configure said second transceiver as a driver or a receiver, based on the output voltage of the third receiver.
